(19) United States
(12) Patent Application Publication
(10) Pub. No.: US 2026/0332455 A1
(43) Pub. Date: Oct. 22, 2026

(54) CHANNEL ESTIMATION METHOD AND APPARATUS

(71) Applicant: BEIJING XIAOMI MOBILE SOFTWARE CO., LTD., Beijing (CN)

(72) Inventor: Xuemei QIAO, Beijing (CN)

(21) Appl. No.: 18/880,825

(22) PCT Filed: Jul. 5, 2022
(86) PCT No.: PCT/CN2022/104000

§ 371 Date: Jan. 2, 2025

(51) Int. Cl. H04L 25/02

(52) U.S. Cl. CPC H04L 25/024; H04L 25/0224

(57) ABSTRACT

A channel estimation method, performed by a terminal device, includes: receiving a first demodulation reference signal (DMRS) transmitted by a network device based on a first DMRS pattern; and performing channel estimation based on a channel estimation model and the first DMRS.

### CROSS-REFERENCE TO RELATED APPLICATIONS

This application is the US national phase application of International Application No. PCT/CN2022/104000, filed on Jul. 5, 2022, the entire contents of which are incorporated herein by reference.

### FIELD

The present disclosure relates to the field of communication technologies, and in particular to a channel estimation method and apparatus.

### BACKGROUND

With the continuous development and maturity of 5G and artificial intelligence (AI) technologies, AI-assisted wireless communications are gradually developing. For example, AI-assisted modulation and demodulation and radio frequency technologies, including AI-assisted channel state information (CSI) feedback and AI-assisted beam management, can improve the speed and coverage of 5G networks, and can improve the mobility and robustness of the system. The AI technology will be integrated into the design of the wireless communication system, which is also an important development direction of 6G in the future.

### SUMMARY

According to a first aspect of embodiments of the present disclosure, a channel estimation method is provided, which is performed by a terminal device. The method includes: receiving a first demodulation reference signal (DMRS) transmitted by a network device based on a first DMRS pattern; and performing channel estimation based on a channel estimation model and the first DMRS.

According to a second aspect of embodiments of the present disclosure, a channel estimation method is provided, which is performed by a network device. The method includes: transmitting a first demodulation reference signal (DMRS) to a terminal device based on a first DMRS pattern, where the first DMRS is used for channel estimation based on a channel estimation model.

According to a third aspect of embodiments of the present disclosure, a channel estimation method is provided, which is performed by a network device. The method includes: receiving a first demodulation reference signal (DMRS) transmitted by a terminal device based on a first DMRS pattern; and performing channel estimation based on a channel estimation model and the first DMRS.

According to a fourth aspect of embodiments of the present disclosure, a terminal device is provided. The device includes a processor, and a memory having stored therein a computer program executable by the processor. The processor is configured to perform the channel estimation method described in the above embodiment in the first aspect.

According to a fifth aspect of embodiments of the present disclosure, a non-transitory computer-readable storage medium is provided. The storage medium stores instructions that, when executed by a processor of a terminal device, cause the terminal device to implement the method described in the first aspect.

A part of additional aspects and advantages of the present disclosure will be set forth in the following description, and the other part thereof will become obvious from the following description, or may be learned by practice of the present disclosure.

### BRIEF DESCRIPTION OF THE DRAWINGS

In order to more clearly explain the technical solutions in embodiments of the present disclosure or the background technology, drawings required to be used in the embodiments of the present disclosure or the background technology will be described below.

FIG. 1 is a schematic architectural diagram of a communication system according to an embodiment of the present disclosure.

FIG. 2 is a schematic flowchart of a channel estimation method according to an embodiment of the present disclosure.

FIG. 3 is a schematic flowchart of a channel estimation method according to an embodiment of the present disclosure.

FIG. 4 is a schematic flowchart of a channel estimation method according to an embodiment of the present disclosure.

FIG. 5 is a schematic flowchart of a channel estimation method according to an embodiment of the present disclosure.

FIG. 6 is a schematic flowchart of a channel estimation method according to an embodiment of the present disclosure.

FIG. 7 is a schematic flowchart of a channel estimation method according to an embodiment of the present disclosure.

FIG. 8 is a schematic flowchart of a channel estimation method according to an embodiment of the present disclosure.

FIG. 9 is a schematic flowchart of a channel estimation method according to an embodiment of the present disclosure.

FIG. 10 is a schematic flowchart of a channel estimation method provided by an embodiment of the present disclosure.

FIG. 11 is a schematic flowchart of a channel estimation method according to an embodiment of the present disclosure.

FIG. 12 is a schematic structural diagram of a channel estimation apparatus according to an embodiment of the present disclosure.

FIG. 13 is a schematic structural diagram of a channel estimation apparatus according to an embodiment of the present disclosure.

FIG. 14 is a schematic structural diagram of a channel estimation apparatus according to an embodiment of the present disclosure.

FIG. 15 is a schematic structural diagram of a channel estimation apparatus according to an embodiment of the present disclosure.

FIG. 16 is a schematic structural diagram of another channel estimation apparatus according to an embodiment of the present disclosure.

FIG. 17 is a schematic structural diagram of a chip according to an embodiment of the present disclosure.

### DETAILED DESCRIPTION

Embodiments will be described in detail herein, examples of which are illustrated in the accompanying drawings. The following description refers to the accompanying drawings in which the same numbers in different drawings refer to the same or similar elements unless otherwise indicated. The implementations set forth in the following description of illustrative embodiments do not represent all implementations consistent with the embodiments of the present disclosure. They are merely examples of apparatuses and methods consistent with some aspects of the embodiments of the present disclosure as recited in the appended claims.

Terms used in the embodiments of the present disclosure are only for the purpose of describing specific embodiments, and shall not be construed to limit the present disclosure. As used in the embodiments of the present disclosure and the appended claims, “a/an” and “the” in a singular form are intended to include plural forms, unless clearly indicated in the context otherwise. It should be understood that, the term “and/or” used herein represents and contains any one of associated listed items and all possible combinations of more than one associated listed items.

It should be understood that terms such as “first”, “second” and “third” may be used in the embodiments of the present disclosure for describing various information, these information should not be limited by these terms. These terms are only used for distinguishing information of the same type from others. For example, first information may also be referred to as second information, and similarly, the second information may also be referred to as the first information, without departing from the scope of the embodiments of the present disclosure. As used herein, the term “if” may be construed to mean “when” or “upon” or “in response to determining” depending on the context.

The embodiments of the present disclosure will be described in detail below, examples of which are illustrated in the accompanying drawings, where the same or similar reference signs refer to the same or similar elements throughout the specification. The embodiments described below with reference to the accompanying drawings are exemplary and are intended to explain the present disclosure, but should not be construed to limit the present disclosure.

In order to better understand the channel estimation method disclosed in the embodiments of the present disclosure, a communication system to which the embodiments of the present disclosure is applicable will be described below.

Referring to FIG. 1, FIG. 1 is a schematic architectural diagram of a communication system according to an embodiment of the present disclosure. The communication system may include, but is not limited to, one network device and one terminal device. The number and form of device shown in FIG. 1 are only for examples and do not constitute a limitation on the embodiments of the present disclosure. In actual disclosures, two or more network devices and two or more terminal devices may be included. The communication system shown in FIG. 1 includes one network device 101 and one terminal device 102, which is taken as an example.

It should be noted that the technical solutions of the embodiments of the present disclosure can be applied to various communication systems, for example, a long term evolution (LTE) system, a fifth generation mobile communication system, a 5G new air interface system, or other future new mobile communication systems.

The network device 101 in the embodiments of the present disclosure is an entity on the network side that is used to transmit or receive signals. For example, the network device 101 may be an evolved NodeB (eNB), a transmission reception point (TRP), a next generation NodeB (gNB) in an NR system, a base station in other future mobile communication systems, an access node in a wireless fidelity (WiFi) system, or the like. The network device 101 in the embodiments of the present disclosure may be the network device itself; or it may be an over the top (OTT) server (OTT server) maintained by an operator, a base station manufacturer or a third party; or it may be operation administration and maintenance (OAM), or location management function (LMF), etc. The specific technology and the specific device form used by the network device are not limited in the embodiments of the present disclosure. The network device provided by the embodiments of the present disclosure may include a centralized unit (CU) and a distributed unit (DU). The CU may also be referred to as a control unit. Protocol layers of the network device, for example, a base station, may be split by means of the structure of CU-DU, where functions of some protocol layers are arranged on the CU for centralized control, some or all of functions of the remaining protocol layers are distributed in the DU, and the CU centrally controls the DU.

The terminal device 102 in the embodiments of the present disclosure is an entity on the user side that is used to receive or transmit signals, such as a mobile phone. The terminal device may also be referred to as a terminal, user equipment (UE), a mobile station (MS), a mobile terminal (MT), etc.; or the terminal device may also be reduced capability user equipment (RedCap UE), evolved reduced capability user equipment (eRedCap UE), etc. The terminal device may be a car with communication functions, a smart car, a mobile phone, a wearable device, a tablet computer (Pad), a computer with wireless transceiver functions, a virtual reality (VR) terminal, an augmented reality (AR) terminal, a wireless terminal in industrial control, a wireless terminal in autonomous driving, a wireless terminal in remote medical surgery, a wireless terminal in a smart grid, a wireless terminal in transportation safety, a wireless terminal in smart city, a wireless terminal in smart home, etc. The terminal device 102 in the embodiments of the present disclosure may be the terminal device itself, or may be a user equipment vendor (UE vendor), a chip manufacturer, or an OTT server maintained by a third party. The specific technology and the specific device form used by the terminal device are not limited in the embodiments of the present disclosure.

With the continuous development and maturity of 5G and artificial intelligence (AI) technologies, AI-assisted wireless communications are gradually developing. For example, AI-assisted modulation and demodulation and radio frequency technologies, including AI-assisted channel state information (CSI) feedback and AI-assisted beam management, can improve the speed and coverage of 5G networks, and can improve the mobility and robustness of the system. The AI technology will be integrated into the design of the wireless communication system, which is also an important development direction of 6G in the future.

In typical AI disclosure scenarios, such as image processing, autonomous driving, etc., the power consumption of AI algorithms can usually be evaluated by FLOPs/mW, FLOPs/W or GFLOPs/mW. FLOPs is the abbreviation of floating point operations, which means floating point operations, may be understood as the amount of computation and may be used to evaluate the complexity of an algorithm or a model. GFLOPs refers to one billion floating point operations.

It should be appreciated that the power consumption of a communication device using an AI model to perform one inference is equal to a ratio of the computational complexity (FLOPs) of the AI model to a capability of the communication device (FLOPs/mW).

For the communication device, FLOPs/mW represents a hardware capability, and is greatly related to a specific CPU process design and a heat dissipation design. In some scenarios, if a computation energy consumption of a terminal is a relatively high, or a computation power supported by a terminal is lower than a certain threshold, AI model training cannot be completed quickly, resulting in model training having to be performed on the network side.

For AI-based downlink channel estimation methods, model training should be performed on the terminal side as much as possible. However, there may be some terminal devices that do not have the capability to train an AI model and require a network device to assist in training.

It should be appreciated that the communication system described in the embodiments of the present disclosure is to more clearly illustrate the technical solutions of the embodiments of the present disclosure, and do not constitute a limitation onto the technical solutions provided by the embodiments of the present disclosure. It is appreciated by those of ordinary skill in the art that, with the evolution of the system architecture and the emergence of new service scenarios, the technical solutions provided in the embodiments of the present disclosure are also applicable to similar technical problems.

The channel estimation method and apparatus provided by the present disclosure will be introduced in detail below with reference to the accompanying drawings.

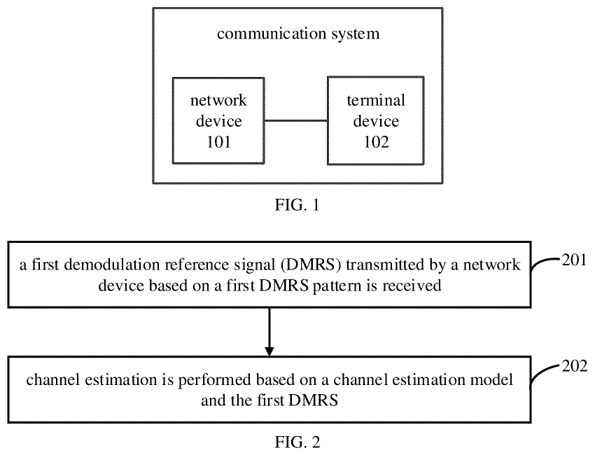

Referring to FIG. 2. FIG. 2 is a schematic flowchart of a channel estimation method according to an embodiment of the present disclosure. It should be noted that the channel estimation method in the embodiment of the present disclosure is performed by the terminal device. The method may be performed independently or in conjunction with any other embodiment of the present disclosure. As shown in FIG. 2, the method may include the following steps.

In step 201, a first demodulation reference signal (DMRS) transmitted by a network device based on a first DMRS pattern is received.

In the embodiment of the present disclosure, the terminal device may receive the first demodulation reference signal (DMRS) transmitted by the network device. The first DMRS is transmitted by the network device based on the first DMRS pattern. After receiving the first DMRS, the terminal device may perform channel estimation based on the first DMRS and a channel estimation model that has been trained.

In some implementations, the terminal device may transmit first indication information to the network device, where the first indication information is used to indicate whether the terminal device has a model training capability.

In an implementation, the first indication information may include at least one of: model training capability indication information of the terminal device; hardware processing capability information of the terminal device; computing capability information of the terminal device; or power consumption capability information of the terminal device.

The model training capability indication information of the terminal device may indicate whether the terminal device has the model training capability. The model training capability indication information may be at least one bit.

In some implementations, the terminal device may also transmit model inference capability indication information of the terminal device to the network device. The model inference capability indication information of the terminal device may indicate whether the terminal device has a capability of using a channel estimation model for model inference. The model inference capability indication information may also be at least one bit.

It may be appreciated that in various embodiments of the present disclosure, the terminal device having a model inference capability is capable of performing channel estimation based on a trained channel estimation model.

In an implementation, the terminal device may determine whether it has a model training capability based on a threshold related to model training and inference configured by the network device or stipulated by a protocol, such as a training delay threshold, a training power consumption threshold, a training computational complexity threshold, etc.; may determine whether it has a model inference capability based on an inference delay threshold, an inference power consumption threshold, and an inference computational complexity threshold; and then may report model training capability indication information and/or model inference capability indication information of the terminal device. The terminal device may also directly determine whether it has the model training capability and the model inference capability based on its own capability, for example, whether it has a graphics processing unit (GPU), or whether it has a neural network processing unit (NPU), or a condition of power storage, etc., and then may report the model training capability indication information and/or the model inference capability indication information of the terminal device.

In an implementation, the terminal device may directly transmit the model training capability indication information and the model inference capability indication information of the terminal device to the network device, for indicating whether the terminal device has the model training capability and whether the terminal device has the model inference capability. In other words, if the terminal device has the model training capability, the terminal device may transmit indication information for indicating that the terminal device has the model training capability to the network device, so as to report that it has the model training capability; if the terminal device does not have the model training capability, the terminal device may directly transmit the model inference capability indication information to the network device, so as to report whether it has the model inference capability. As an example, the terminal device may transmit indication information for indicating that it has the model training capability to the network device, so as to report that it has the model training capability, which implicitly indicates that the terminal device also has the model inference capability. As another example, the terminal device transmits indication information for indicating that it has the model inference capability to the network device, so as to report that the terminal device has the model inference capability, which implicitly indicates that the terminal device does not have the model training capability.

In some implementations, the terminal device may transmit to the network device hardware processing capability information, computing capability information, power consumption capability information, etc., and the network device may determine whether the terminal device has the model training capability and whether the terminal device has the model inference capability based on some thresholds according to delay requirements of a service or stipulated by protocols, such as a delay threshold, a power consumption threshold, a computational complexity threshold, etc.

In an implementation, the first indication information may be included in at least one of the following signaling: UE capability; UE assistance information (UAI); radio resource control (RRC) signaling; medium access control (MAC) control element (CE); or uplink control information (UCI). The first indication information may also be transmitted via a physical uplink shared channel (PUSCH).

In step 202, channel estimation is performed based on a channel estimation model and the first DMRS.

In the embodiment of the present disclosure, the terminal device can perform channel estimation based on the received first DMRS and a trained channel estimation model.

It may be appreciated that in the embodiment of the present disclosure, the terminal device may directly use a received DMRS signal as an input of the channel estimation model, or may obtain a channel estimated value estimated based on the DMRS and may use the channel estimated value as an input of the channel estimation model, which is not limited in the present disclosure. The performing estimation based on the DMRS to obtain the channel estimated value at the DMRS may include performing estimation by using the least square (LS) method, or the minimum mean square error (MMSE) method, or other estimation algorithms, etc., and the present disclosure is not limited thereto.

In the embodiments of the present disclosure, the training the channel estimation model may be performed by the terminal device or the network device; the training may be performed by using actual data or simulation data; the training may be performed offline or online.

In some implementations, the terminal device may receive a second DMRS transmitted by the network device based on a second DMRS pattern, and may determine training data for the channel estimation model based on the second DMRS.

In an implementation, the terminal device may train the channel estimation model by using the determined training data.

In an implementation, the terminal device may transmit the training data to the network device, and the network device uses the training data to train the channel estimation model.

In an implementation, before determining the training data to be transmitted to the network device, the terminal device may also receive fourth indication information transmitted by the network device, where the fourth indication information is used to indicate a type of the training data. For example, it may be indicated that the training data is a received signal corresponding to the second DMRS, or it may be indicated that the training data is a channel estimated value estimated based on the second DMRS. The terminal device may determine which type of training data is required by the network device for model training according to indication of the fourth indication information, may determine the training data according to the received second DMRS and may transmit the same to the network device.

In some implementations, the terminal device may obtain a simulation signal received by the terminal device in a simulation channel, where the simulation signal is a second DMRS transmitted by the network device based on a second DMRS pattern in the simulation channel. The terminal device may determine simulation training data for the channel estimation model according to the simulation signal, and may train the channel estimation model by using the simulation training data.

In some implementations, the channel estimation model is trained by the network device using simulation training data. The network device may also obtain the simulation signal received by the terminal device in a simulation channel, where the simulation signal is a second DMRS transmitted by the network device based on a second DMRS pattern in the simulation channel. The network device may also determine the simulation training data for the channel estimation model based on the simulation signal, and may train the channel estimation model by using the simulation training data.

In an embodiment of the present disclosure, in a case where the channel estimation model is trained by the network device, the terminal device may receive a trained channel estimation model transmitted by the network device.

In some implementations of the embodiments of the present disclosure, in a case where the channel estimation model is trained by the terminal device, the terminal device may also transmit second indication information to the network device, where the second indication information is used to indicate that training of the channel estimation model is completed.

In an implementation, the second indication information may further include at least one of: capability information of the channel estimation model, or processing delay information of the channel estimation model.

The capability information of the channel estimation model refers to a capability of the channel estimation model as compared with conventional channel estimation methods. For example, the model is capable of using a DMRS with a lower density for channel estimation as compared with conventional patterns, or the model is capable of obtaining a channel estimation result with a higher precision as compared with conventional channel estimation methods, etc. The processing delay information of the channel estimation model refers to a processing delay of the terminal device when using the model, which may include a loading time of the model, a time of using the model for inference, etc.

The network device may determine that training the channel estimation model has been completed based on the second indication information. At the same time, the network device may also obtain the capability information of the model and/or the processing delay information of the model, and may perform reasonable scheduling on the terminal device based on the capability information and the processing delay information.

In an implementation, the second indication information may be included in at least one of the following signaling: UE capability; UE assistance information (UAI); radio resource control (RRC) signaling; medium access control control element (MAC CE); or uplink control information (UCI). The second indication information may also be transmitted via a physical uplink shared channel (PUSCH).

In some implementations, in a case where the channel estimation model is trained by the terminal device, the terminal device may also receive third indication information transmitted by the network device. The third indication information is used to instruct the terminal device to start to train the channel estimation model. The third indication information may be at least one bit.

In some implementations, in a case where the channel estimation model is trained by the terminal device, the terminal device may directly start to train the channel estimation model, or may start to train the model after more than a preset duration after transmitting the first indication information. The preset duration may be configured by the network device, or agreed or stipulated by a protocol.

In some implementations, the network device may also transmit disable signaling to the terminal device according to service needs, conditions and the like, to instruct the terminal device not to start model training.

In some implementations, in a case where the channel estimation model is trained in a supervised machine learning manner, the terminal device may also receive an impulse signal transmitted by the network device and may obtain an ideal channel estimation label of a channel based on the impulse signal. The ideal channel estimation label is used for training the channel estimation model.

In some implementations, in a case where the channel estimation model is trained by the terminal device, if the channel estimation model is trained in a supervised machine learning manner, the terminal device also needs to transmit auxiliary information to the network device, to request the network device to transmit an impulse signal. The terminal device may obtain the ideal channel estimation label of the channel based on the impulse signal, and may train the channel estimation model by using the ideal channel estimation label.

In some implementations, the channel estimation model has a capability of using low-density DMRS for channel estimation, and a density of the first DMRS pattern is lower than a density of the second DMRS pattern. The second DMRS pattern may be a legacy DMRS pattern. The terminal device may obtain a channel estimation result based on the channel estimation model by using a DMRS with the lower density than the legacy DMRS pattern.

In some implementations, the channel estimation model has a capability of generating a high-precision channel estimation result, and a density of the first DMRS pattern is the same as a density of the second DMRS pattern. The second DMRS pattern may be a legacy DMRS pattern. The terminal device may obtain a higher-precision channel estimation result based on the channel estimation model by using the DMRS with the same density as the legacy DMRS pattern, as compared with conventional channel estimation methods.

In some implementations, the terminal device may also receive fifth indication information transmitted by the network device, where the fifth indication information is used to instruct the terminal device to perform channel estimation based on the channel estimation model. The trained channel estimation model will be enabled for channel estimation, only when the terminal device receives the fifth indication information.

In an implementation, the fifth indication information may be at least one bit, which directly instructs the terminal device to enable the trained channel estimation model to perform channel estimation. The fifth indication information may also be configuration of the first DMRS pattern transmitted by the network device to the terminal device, so as to reduce pilot overhead.

In summary, by receiving a first demodulation reference signal (DMRS) transmitted by a network device based on a first DMRS pattern and performing channel estimation based on a channel estimation model and the first DMRS, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

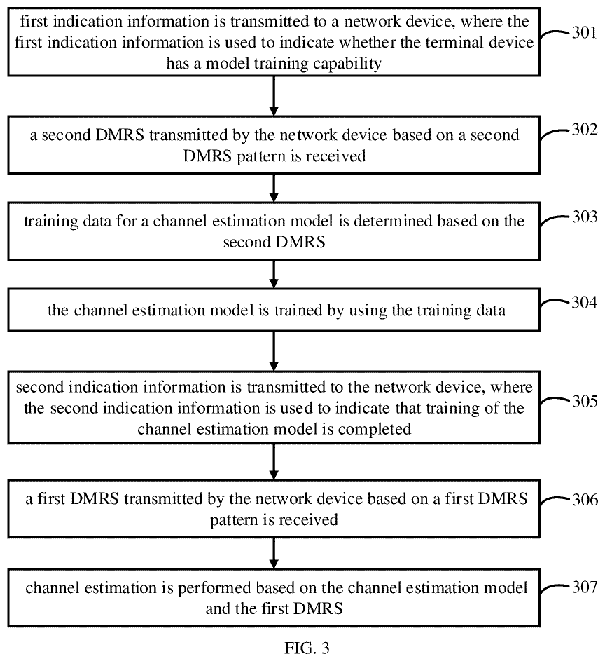

Referring to FIG. 3, FIG. 3 is a schematic flowchart of a channel estimation method according to an embodiment of the present disclosure. It should be noted that the channel estimation method in the embodiment of the present disclosure is performed by a terminal device. The method may be performed independently or in conjunction with any other embodiment of the present disclosure. As shown in FIG. 3, the method may include the following steps.

In step 301, first indication information is transmitted to a network device, where the first indication information is used to indicate whether the terminal device has a model training capability.

In the embodiment of the present disclosure, the terminal device transmits the first indication information to the network device, to report whether it has the model training capability.

In an implementation, the first indication information may include at least one of: model training capability indication information of the terminal device; hardware processing capability information of the terminal device; computing capability information of the terminal device; or power consumption capability information of the terminal device.

The model training capability indication information of the terminal device may indicate whether the terminal device has the model training capability. The model training capability indication information may be at least one bit. As an example, value “0” may be used to represent that the terminal device does not have the model training capability, and value “1” may be used to represent that the terminal device has the model training capability.

In some implementations, the terminal device may also transmit model inference capability indication information of the terminal device to the network device. The model inference capability indication information of the terminal device may indicate whether the terminal device has a capability of using a channel estimation model for model inference. The model inference capability indication information may also be at least one bit. As an example, value “0” may be used to represent that the terminal device does not have the model inference capability, and value “1” may be used to represent that the terminal device has the model inference capability.

It may be appreciated that in various embodiments of the present disclosure, the terminal device having the model inference capability is capable of performing channel estimation based on a trained channel estimation model.

In an implementation, the terminal device may determine whether it has the model training capability based on a threshold related to model training and inference configured by the network device or stipulated by a protocol, such as a training delay threshold, a training power consumption threshold, a training computational complexity threshold, etc.; may determine whether it has the model inference capability based on an inference delay threshold, an inference power consumption threshold, and an inference computational complexity threshold, and then may report model training capability indication information and/or model inference capability indication information of the terminal device. The terminal device may also directly determine whether it has the model training capability and the model inference capability based on its own capability, for example, whether it has a GPU, whether it has a NPU, or a condition of power storage, etc., and then may report the model training capability indication information and/or the model inference capability indication information of the terminal device.

In an implementation, the terminal device may directly transmit the model training capability indication information and the model inference capability indication information of the terminal device to the network device, for indicating whether the terminal device has the model training capability and whether the terminal device has the model inference capability. In other words, if the terminal device has the model training capability, the terminal device may transmit indication information for indicating that the terminal device has the model training capability to the network device, so as to report that it has the model training capability; if the terminal device does not have the model training capability, the terminal device may directly transmit the model inference capability indication information to the network device, so as to report whether it has the model inference capability. As an example, the terminal device may transmit indication information for indicating that it has the model training capability to the network device, so as to report that it has the model training capability, which implicitly indicates that the terminal device also has the model inference capability. As another example, the terminal device transmits indication information for indicating that it has the model inference capability to the network device, so as to report that the terminal device has the model inference capability, which implicitly indicates that the terminal device does not have the model training capability.

In some implementations, the terminal device may transmit to the network device hardware processing capability information, computing capability information, power consumption capability information, etc., and the network device may determine whether the terminal device has the model training capability and whether the terminal device has the model inference capability based on some thresholds according to delay requirements of a service or stipulated by protocols, such as a delay threshold, a power consumption threshold, a computational complexity threshold, etc.

In some implementations, the terminal device may have at least one capability including model training capability and/or at least one model inference capability, and the first indication information may be used to determine the model training capability and/or model inference capability of the terminal device. As an example, the first indication information is model training capability indication information, where value “00” of the model training capability indication information represents that the terminal device does not have the model training capability, and values “01”, “02” and “03” of the model training capability indication information all represent that the terminal device has the model training capability. Different values represent different levels of the model training capability, and the greater the value is, the stronger the training capability is. Similarly, the model inference capability indication information may also be reported in a similar manner. It may be appreciated that other methods may also be used to determine the model training capability of the terminal device, which is not limited in the present disclosure.

In an implementation, the first indication information may be included in at least one of the following signaling: UE capability; UE assistance information (UAI); radio resource control (RRC) signaling; medium access control control element (MAC CE); or uplink control information (UCI). The first indication information may also be transmitted via a physical uplink shared channel (PUSCH).

It may be appreciated that in the embodiments of the present disclosure, the terminal device has the model training capability and the model inference capability.

In step 302, a second DMRS transmitted by the network device based on a second DMRS pattern is received.

In the embodiment of the present disclosure, the terminal device may receive the second DMRS transmitted by the network device based on the second DMRS pattern, may determine training data for the channel estimation model based on the second DMRS, and may train the channel estimation model by using the training data.

The second DMRS pattern may be a legacy DMRS pattern.

In the embodiment of the present disclosure, the network device transmits a reference signal to the terminal device based on the second DMRS pattern, and the terminal device collects actual data as training data for model training based on the actually received reference signal.

In step 303, training data for a channel estimation model is determined based on the second DMRS.

In the embodiment of the present disclosure, the terminal device may determine the training data for the channel estimation model based on the received second DMRS, and the training data is actual data obtained by means of actual channel transmission.

In an implementation, in an embodiment of the present disclosure, the terminal device may directly use the received second DMRS signal as training data for the channel estimation model, or may obtain a channel estimated value estimated based on the second DMRS and may use the channel estimated value as training data for the channel estimation model, or may also obtain other training data based on configuration of the channel estimation model, which is not limited in the present disclosure. The performing channel estimation based on the second DMRS to obtain the channel estimated value at the DMRS may include performing estimation by using the least square (LS) method, or the minimum mean square error (MMSE) method, or other estimation algorithms, etc., and the present disclosure is not limited thereto.

In some implementations, the terminal device uses a supervised machine learning method to train the channel estimation model, the terminal device may also receive an impulse signal transmitted by the network device, and may obtain an ideal channel label of a channel based on the impulse signal, used for training the channel estimation model.

In an implementation, the impulse signal may be transmitted in a semi-persistent scheduling manner. The terminal device may also receive configuration information of the impulse signal transmitted by the network device, which may include a transmission period of the impulse signal and time-frequency resources occupied by the impulse signal, etc. The impulse signal may also be transmitted in a dynamic scheduling manner. The terminal device may also receive scheduling information of the impulse signal transmitted by the network device, which may include a time-frequency domain resource occupied by impulse signal transmission, an action indication filed of a DCI (such as dedicatedly used for scheduling the impulse signal), and the like.

In step 304, the channel estimation model is trained by using the training data.

In the embodiment of the present disclosure, the terminal device may use the training data determined in the previous steps to train the channel estimation model.

In the embodiment of the present disclosure, the channel estimation model may be trained in a supervised machine learning manner or in an unsupervised machine learning manner.

It should be noted that the channel estimation model in the embodiment of the present disclosure may be constructed and trained based on any one of machine learning methods, such as convolutional neural networks (CNN), etc., which is not limited in the present disclosure.

In some implementations, the terminal device trains the channel estimation model in a supervised machine learning manner, and the terminal device may also use the ideal channel label of the channel obtained based on the received impulse signal to train the channel estimation model.

It should be noted that the impulse signal transmitted by the network device may be transmitted separately from the second DMRS, or may be transmitted together with the second DMRS, which is not limited in the present disclosure.

In some implementations, the terminal device trains the channel estimation model in a supervised machine learning manner, and the terminal device may also transmit auxiliary information to the network device, where the auxiliary information is used to request the impulse signal. After receiving the auxiliary information, the network device transmits the impulse signal to the terminal device.

In an implementation, the auxiliary information may be a request message, or may be indication information for indicating a training manner of the channel estimation model (for example, indicating that the model is trained in a supervised/unsupervised machine learning manner).

In some implementations, the terminal device may also receive third indication information transmitted by the network device, and the third indication information is used to instruct the terminal device to start model training.

In an implementation, the third indication information may be bit information taking a value as “0” or “1”, used to indicate whether the terminal device enables model training (for example, value “0” of the third indication information indicates disablement, and the terminal device does not start model training; and value “1” of the third indication information indicates enablement, and the terminal device starts model training). The third indication information may also be an impulse signal transmitted by the network device, or a corresponding configuration of the impulse signal. Receiving the signal or the corresponding configuration of the signal means that the terminal device is enabled to start model training, and after receiving the impulse signal or the corresponding configuration of the impulse signal, the terminal device can start to train the channel estimation model.

In some implementations, the terminal device may directly start to train the channel estimation model, or may start to train the channel estimation model after more than a preset duration after transmitting the first indication information. The preset duration may be configured by the network device, or agreed or stipulated by a protocol.

It should be noted that in the embodiment of the present disclosure, the training of the model may be performed online or offline, which is not limited in the present disclosure.

In step 305, second indication information is transmitted to the network device, where the second indication information is used to indicate that training of the channel estimation model is completed.

In the embodiment of the present disclosure, after completing the training the channel estimation model, the terminal device may also transmit second indication information to the network device, and the network device may determine that the training of the channel estimation model is completed based on the second indication information.

In an implementation, in addition to indication information for indicating completion of the model training, the second indication information may also include at least one of: capability information of the channel estimation model, or processing delay information of the channel estimation model. Alternatively, the indication information for indicating completion of the model training is implicitly indicated by at least one of the above two types of information.

The capability information of the channel estimation model refers to a capability of the channel estimation model as compared with conventional channel estimation methods. For example, the model is capable of using a DMRS with a lower density for channel estimation as compared with conventional patterns, or the model is capable of obtaining a channel estimation result with a higher precision as compared with conventional channel estimation methods, etc. The processing delay information of the channel estimation model refers to a processing delay of the terminal device when using the model, which may include a loading time of the model, a time of using the model for inference, etc.

The network device may determine that the channel estimation model has been trained based on the second indication information. At the same time, the network device may also obtain the capability information of the model and/or information such as the processing delay of the model, the model complexity, the model inference power consumption, or etc., may reasonably schedule the terminal device based on the capability information and the processing delay information; and may decide whether to enable an AI model based on the information such as the processing delay of the model, the model complexity, the model inference power consumption, or etc.

In an implementation, the second indication information may be included in at least one of the following signaling: UE capability; UE assistance information (UAI); radio resource control (RRC) signaling; medium access control control element (MAC CE); or uplink control information (UCI). The second indication information may also be transmitted via a physical uplink shared channel (PUSCH).

In step 306, a first DMRS transmitted by the network device based on a first DMRS pattern is received.

In the embodiment of the present disclosure, the terminal device may receive the first DMRS transmitted by the network device, and the first DMRS is transmitted by the network device based on the first DMRS pattern. The network device may determine the first DMRS pattern based on the capability of the channel estimation model. After receiving the first DMRS, the terminal device may perform channel estimation based on the first DMRS and a trained channel estimation model.

In some implementations, the channel estimation model has a capability of using low-density DMRS for channel estimation, and a density of the first DMRS pattern is lower than a density of the second DMRS pattern. The second DMRS pattern may be a legacy DMRS pattern. The terminal device may obtain a channel estimation result based on the channel estimation model by using the DMRS with the lower density than the legacy DMRS pattern.

In some implementations, the channel estimation model has a capability of generating a high-precision channel estimation result, and a density of the first DMRS pattern is the same as a density of the second DMRS pattern. The second DMRS pattern may be a legacy DMRS pattern, and the terminal device may obtain a higher-precision channel estimation result based on the channel estimation model by using the DMRS with the same density as the legacy DMRS pattern, as compared with conventional channel estimation methods.

It may be appreciated that in the embodiment of the present disclosure, the terminal device may directly use the received first DMRS signal as an input of the channel estimation model, or may obtain a channel estimated value estimated based on the first DMRS and may use the channel estimated value as an input of the channel estimation model, or may also use other training data obtained based on configuration of the channel estimation model as an input, which is not limited in the present disclosure. The performing channel estimation based on the first DMRS to obtain the channel estimated value may include performing estimation by using the least square (LS) method, or the minimum mean square error (MMSE) method, or other estimation algorithms, etc., and the present disclosure is not limited thereto.

In step 307, channel estimation is performed based on the channel estimation model and the first DMRS.

In the embodiment of the present disclosure, the terminal device may perform channel estimation based on the received first DMRS and a trained channel estimation model.

It may be appreciated that in the embodiments of the present disclosure, the terminal device may directly use the received first DMRS signal as an input of the channel estimation model, or may use a channel estimated value estimated based on the first DMRS as an input of the channel estimation model, or may use other data obtained based on configuration of the channel estimation model as an input, which is not limited in the present disclosure. The performing channel estimation based on the first DMRS to obtain the channel estimated value may include performing estimation by using the least square (LS) method, or the minimum mean square error (MMSE) method, or other estimation algorithms, etc., which is not limited in the present disclosure.

In some implementations, the terminal device may also receive fifth indication information transmitted by the network device, where the fifth indication information is used to instruct the terminal device to perform channel estimation based on the channel estimation model. The trained channel estimation model will not be enabled for channel estimation, until the terminal device receives the fifth indication information.

In an implementation, the fifth indication information may be at least one bit, which directly instructs the terminal device to enable the trained channel estimation model for channel estimation (for example, value “0” of the fifth indication information indicates disablement, and the terminal device disables the channel estimation model for channel estimation; value “1” of the fifth indication information indicates enablement, and the terminal device enables the channel estimation model for channel estimation). The fifth indication information may be a configuration of the first DMRS pattern transmitted by the network device to the terminal device, so as to reduce pilot overhead.

It may be appreciated that if the terminal device disables the channel estimation model for channel estimation, densities of the first DMRS pattern and the second DMRS pattern are the same, and the terminal device may use a conventional channel estimation algorithm to perform channel estimation based on the received DMRS.

In summary, first indication information is transmitted to a network device, where the first indication information is used to indicate whether a terminal device has a model training capability; a second DMRS transmitted by the network device based on a second DMRS pattern is received; training data for a channel estimation model is determined based on the second DMRS; the channel estimation model is trained by using the training data; second indication information is transmitted to the network device, where the second indication information is used to indicate that training of the channel estimation model is completed; a first DMRS transmitted by the network device based on a first DMRS pattern is received; channel estimation is performed based on the channel estimation model and the first DMRS. In this way, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

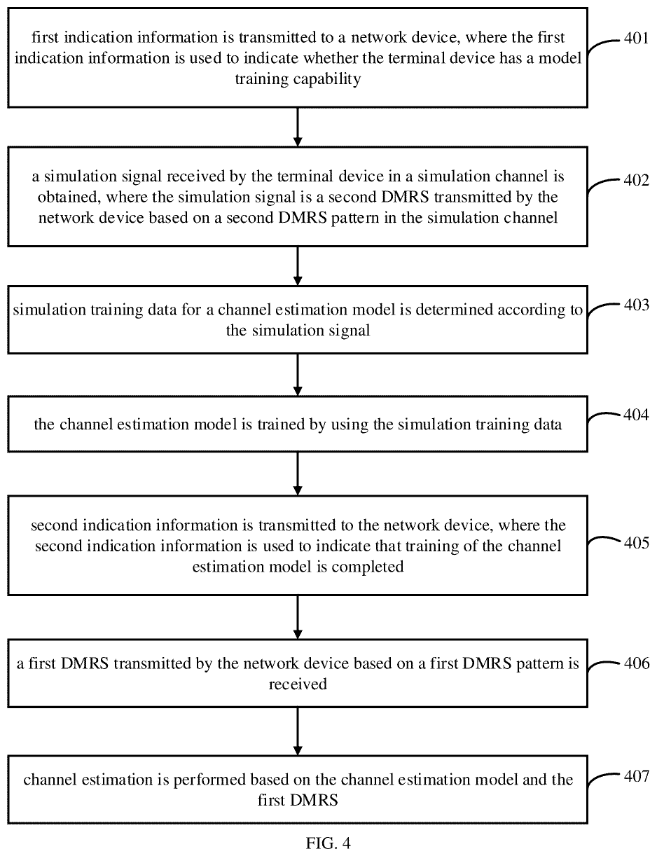

Referring to FIG. 4, FIG. 4 is a schematic flowchart of a channel estimation method according to an embodiment of the present disclosure. It should be noted that the channel estimation method in the embodiment of the present disclosure is performed by a terminal device. The method may be performed independently or in conjunction with any other embodiment of the present disclosure. As shown in FIG. 4, the method may include the following steps.

In step 401, first indication information is transmitted to a network device, where the first indication information is used to indicate whether the terminal device has a model training capability.

In the embodiment of the present disclosure, step 401 may be implemented in any of manners in the embodiments of the present disclosure, which is not limited by the embodiment of the present disclosure and will not be repeated again.

In step 402, a simulation signal received by the terminal device in a simulation channel is obtained, where the simulation signal is a second DMRS transmitted by the network device based on a second DMRS pattern in the simulation channel.

In an embodiment of the present disclosure, the terminal device may obtain the simulation signal received by the terminal device in the simulation channel, and the simulation signal is the second DMRS transmitted by the network device based on the second DMRS pattern in the simulation channel. The training data for the channel estimation model may be determined based on the simulation signal, and the training data may be used to train the channel estimation model.

The second DMRS pattern may be a legacy DMRS pattern.

In an embodiment of the present disclosure, in a simulation channel model, the network device transmits DMRS to the terminal device based on the second DMRS pattern, the terminal device may obtain the simulation signal received in the simulation channel, and may determine the simulation data as training data to perform model training.

In step 403, simulation training data for a channel estimation model is determined according to the simulation signal.

In the embodiment of the present disclosure, the terminal device may determine the training data for the channel estimation model based on the obtained simulation signal, and the training data is simulation data transmitted in the simulation channel.

In an implementation, in an embodiment of the present disclosure, the terminal device may directly use the simulation signal of the received second DMRS as training data for the channel estimation model, or may obtain a channel estimated value estimated based on the simulation signal of the second DMRS and may use the channel estimated value as training data for the channel estimation model, or may also obtain other training data based on configuration of the channel estimation model, which is not limited in the present disclosure. The performing channel estimation based on the second DMRS to obtain the channel estimated value at the DMRS may include performing estimation by using the least square (LS) method, or the minimum mean square error (MMSE) method, or other estimation algorithms, etc., which is not limited in the present disclosure.

In some implementations, the terminal device uses a supervised machine learning method to train the channel estimation model, the terminal device may also obtain an ideal channel label of the simulation channel, which is used for training the channel estimation model.

In step 404, the channel estimation model is trained by using the simulation training data.

In the embodiment of the present disclosure, the terminal device can use the simulation training data determined in the previous steps to train the channel estimation model.

In the embodiment of the present disclosure, the channel estimation model may be trained in a supervised machine learning manner or an unsupervised machine learning manner.

It should be noted that the channel estimation model in the embodiment of the present disclosure may be constructed and trained based on any one of machine learning methods, such as convolutional neural networks (CNN), etc., and the present disclosure is not limited thereto.

In some implementations, the channel estimation model is trained by the terminal device in a supervised machine learning manner, and the terminal device may also obtain the ideal channel label of the simulation channel to train the channel estimation model. It may be appreciated that in the simulation channel model, the ideal channel label of the simulation channel may be obtained via channel parameters for establishing the simulation channel model.

In some implementations, the terminal device may also receive third indication information transmitted by the network device, where the third indication information is used to instruct the terminal device to start to train the model.

In an implementation, the third indication information may be bit information taking a value as “0” or “1”, used to indicate whether the terminal device enables model training (for example, value “0” of the third indication information indicates disablement, and the terminal device does not start model training; and value “1” of the third indication information indicates enablement, and the terminal device starts model training). The third indication information may also be other information, which instructs the terminal device to start model training in an implicit indication manner.

In some implementations, the terminal device may directly start to train the channel estimation model, or may start to train the channel estimation model after more than a preset duration after transmitting the first indication information. The preset duration may be configured by the network device, or agreed or stipulated by a protocol.

It should be noted that in the embodiment of the present disclosure, the training of the model may be performed online or offline, which is not limited in the present disclosure.

In some implementations, the terminal device may also transmit indication information of training data to the network device, and the indication information of the training data is used to indicate the terminal device whether simulation data or actual data is used for model training. The network device may also configure or instruct, explicitly or implicitly, the terminal device whether simulation data or actual data is used for model training (for example, it may implicitly indicate to use actual data for model training by transmitting an impulse signal).

In step 405, second indication information is transmitted to the network device, where the second indication information is used to indicate that training of the channel estimation model is completed.

In step 406, a first DMRS transmitted by the network device based on a first DMRS pattern is received.

In step 407, channel estimation is performed based on the channel estimation model and the first DMRS.

In the embodiment of the present disclosure, steps 405 to 407 may be implemented in any of manners in the embodiments of the present disclosure, which is not limited by the embodiments of the present disclosure, and will not be described again.

In summary, first indication information is transmitted to a network device, where the first indication information is used to indicate whether a terminal device has a model training capability; a simulation signal received by the terminal device in a simulation channel is obtained, where the simulation signal is a second DMRS transmitted by the network device based on a second DMRS pattern in the simulation channel; simulation training data for a channel estimation model is determined according to the simulation signal; the channel estimation model is trained by using the simulation training data; second indication information is transmitted to the network device, where the second indication information is used to indicate that training of the channel estimation model is completed; a first DMRS transmitted by the network device based on a first DMRS pattern is received; and channel estimation is performed based on the channel estimation model and the first DMRS. In this way, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

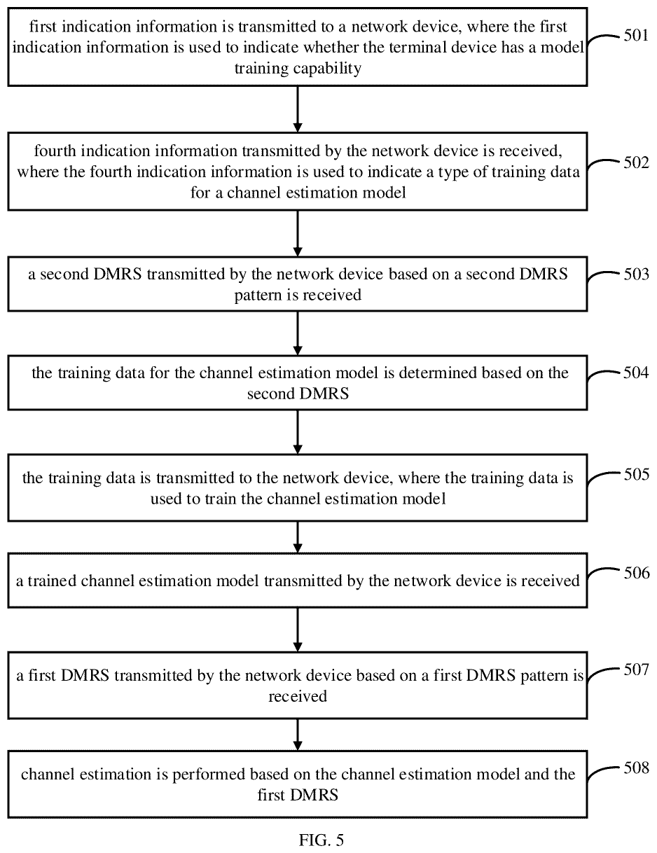

Referring to FIG. 5, FIG. 5 is a schematic flowchart of a channel estimation method according to an embodiment of the present disclosure. It should be noted that the channel estimation method in the embodiment of the present disclosure is performed by a terminal device. This method may be performed independently or in conjunction with any other embodiment of the present disclosure. As shown in FIG. 5, the method may include the following steps.

In step 501, first indication information is transmitted to a network device, where the first indication information is used to indicate whether the terminal device has a model training capability.

In the embodiment of the present disclosure, step 501 may be implemented in any of manners in the embodiments of the present disclosure, which is not limited by the embodiment of the present disclosure and will not be repeated again.

It may be appreciated that in the embodiments of the present disclosure, the network device training the channel estimation model means that the terminal device does not have the model training capability or the terminal device has the model training capability, but the network device may choose not to perform model training on the side of the terminal device based on a service condition, etc.

In the embodiment of the present disclosure, in a case where the first indication information is model training capability indication information of the terminal device, the terminal device may also need to transmit storage capability information, hardware processing capability information, computing capability information, power consumption capability information, or the like to the network device, used by the network device to determine a channel estimation model that matches the terminal device. Alternatively, the terminal device may also transmit model recommendation information to the network device based on its own hardware capability, used by the network device to determine a channel estimation model that matches the terminal device.

In step 502, fourth indication information transmitted by the network device is received, where the fourth indication information is used to indicate a type of training data for a channel estimation model.

In the embodiment of the present disclosure, the terminal device may receive fourth indication information transmitted by the network device, where the fourth indication information is used to indicate the type of the training data. For example, it may be indicated that the training data is a received signal corresponding to the second DMRS, or it may be indicated that the training data is a channel estimated value at DMRS estimated based on the second DMRS, or another type of training data may be indicated based on configuration of the channel estimation model, which is not limited by the present disclosure.

The terminal device may determine which type of training data is required by the network device for model training according to indication of the fourth indication information, may determine the training data according to the received second DMRS and may transmit the same to the network device.

In step 503, a second DMRS transmitted by the network device based on a second DMRS pattern is received.

In the embodiment of the present disclosure, the terminal device may receive the second DMRS transmitted by the network device based on the second DMRS pattern, and may determine the training data for the channel estimation model based on the second DMRS. The training data is required by the network device for model training.

The second DMRS pattern may be a legacy DMRS pattern.

In step 504, the training data for the channel estimation model is determined based on the second DMRS.

In the embodiment of the present disclosure, the terminal device may determine the training data for the channel estimation model based on the received second DMRS, and the training data is actual data obtained via actual channel transmission.

In an embodiment of the present disclosure, the terminal device may determine the training data based on the type of training data indicated by the received fourth indication information. For example, it is determined based on the fourth indication information that the training data is a received signal corresponding to the second DMRS, or it is determined based on the fourth indication information that the training data is a channel estimated value estimated based on the second DMRS. The performing channel estimation based on the second DMRS to obtain the channel estimated value at the DMRS may include performing estimation by using the least square (LS) method, or the minimum mean square error (MMSE) method, or other estimation algorithms, etc., which is not limited in the present disclosure.

In some implementations, the channel estimation model is trained by the network device in a supervised machine learning manner. The terminal device may also receive an impulse signal transmitted by the network device, may obtain an ideal channel label of a channel based on the impulse signal, and may transmit the ideal channel label and the training data to the network device together. The ideal channel label is used for training the channel estimation model.

In an implementation, the impulse signal may be transmitted in a semi-persistent scheduling manner. The terminal device may also receive configuration information of the impulse signal transmitted by the network device, which may include a transmission period of the impulse signal and time-frequency resources occupied by the impulse signal, etc. The impulse signal may also be transmitted in a dynamic scheduling manner. The terminal device may also receive scheduling information of the impulse signal transmitted by the network device, which may include time-frequency domain resources occupied by impulse signal transmission, an action indication filed of a DCI (such as dedicatedly used for scheduling the impulse signal), and the like.

In some implementations, the terminal device may also receive configuration information or indication information for reporting training data transmitted by the network device, which is used to configure or indicate the terminal device a reporting period of the training data, a dimension of the training data to be reported, an amount of the training data to be reported, a time-frequency resource used to report the training data, and the like.

It may be appreciated that if the channel estimation model is trained by the network device in a supervised machine learning manner, the terminal device also needs to transmit an ideal channel label obtained via the received impulse signal and the training data to the network device together. For example, {training input value, label} included by a sample is {received signal of DMRS, data and ideal channel estimated value at DMRS} or {channel estimated value at DMRS, data and ideal channel estimated value at DMRS}.

In step 505, the training data is transmitted to the network device, where the training data is used to train the channel estimation model.

In the embodiment of the present disclosure, the terminal device may transmit the determined training data to the network device, and the network device uses the training data to train the channel estimation model.

In an embodiment of the present disclosure, the channel estimation model may be trained in a supervised machine learning manner or an unsupervised machine learning manner.

It should be noted that the channel estimation model in the embodiment of the present disclosure may be constructed and trained based on any one of machine learning methods, such as convolutional neural networks (CNN), etc., and the present disclosure is not limited thereto.

In some implementations, the channel estimation model is trained by the network device in a supervised machine learning manner, and the terminal device may transmit the ideal channel label of the channel. The ideal channel label of the simulation channel may be obtained based on the received impulse signal from the network device.

It should be noted that the impulse signal transmitted by the network device may be transmitted separately from the second DMRS, or may be transmitted together with the second DMRS, which is not limited in the present disclosure.

In some implementations, the terminal device may also receive configuration information or indication information for reporting training data transmitted by the network device, and may transmit the training data and/or the ideal channel label based on a reporting period of the training data, a dimension of the training data to be reported, an amount of the training data to be reported, a time-frequency resource used to report the training data, and the like, which are configured or indicated by the configuration information or indication information.

In step 506, a trained channel estimation model transmitted by the network device is received.

In the embodiment of the present disclosure, the terminal device may receive the trained channel estimation model transmitted by the network device.

In an implementation, the network device may transmit the trained channel estimation model to the terminal device in a form such as RRC signaling, a new signaling radio bearer (SRB), or a channel identified by a unique logical channel identity (LCID).

In an embodiment of the present disclosure, the network device can use actual channel data transmitted by the terminal device as training data to train the channel estimation model. The network device may perform model training by itself, or the model training is performed by an OTT server, OAM, LMF, or the like.

In an embodiment of the present disclosure, the model trained by the network device may be determined based on model recommendation information reported by the terminal device. Alternatively, the model may be a model determined by the network device, which matches the capability of the terminal device (for example, the model is determined by the network device based on storage capacity, hardware processing capability information, computing capability information, power consumption capability information, or the like reported by the terminal device, and matches the terminal device). Alternatively, the model may be directly determined by the network device, and may be not based on the capability of the terminal device.

It should be noted that in an embodiment of the present disclosure, the training of the model may be performed online or offline, which is not limited in the present disclosure.

In step 507, a first DMRS transmitted by the network device based on a first DMRS pattern is received.

In step 508, channel estimation is performed based on the channel estimation model and the first DMRS.

In the embodiments of the present disclosure, steps 507 and 508 may be implemented in any of manners in the embodiments of the present disclosure, which is not limited by the embodiment of the present disclosure and will not be repeated again.

In summary, first indication information is transmitted to a network device, where the first indication information is used to indicate whether a terminal device has a model training capability; fourth indication information transmitted by the network device is received, where the fourth indication information is used to indicate a type of training data for a channel estimation model; a second DMRS transmitted by the network device based on a second DMRS pattern is received; the training data for the channel estimation model is determined based on the second DMRS; the training data is transmitted to the network device, where the training data is used to train the channel estimation model; a trained channel estimation model transmitted by the network device is received; a first DMRS transmitted by the network device based on a first DMRS pattern is received; and channel estimation is performed based on the channel estimation model and the first DMRS. In this way, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

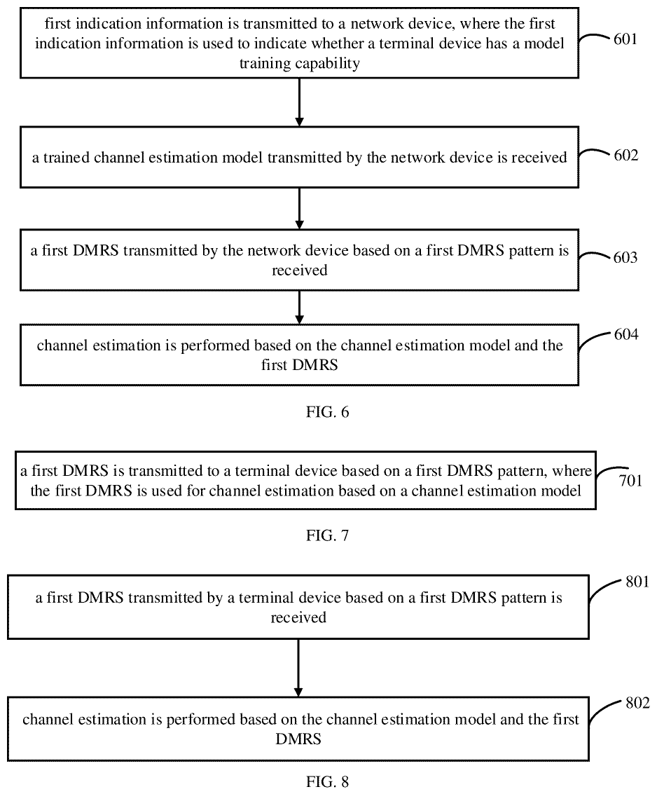

Referring to FIG. 6, FIG. 6 is a schematic flowchart of a channel estimation method according to an embodiment of the present disclosure. It should be noted that the channel estimation method in the embodiment of the present disclosure is performed by a terminal device. This method may be performed independently or in conjunction with any other embodiment of the present disclosure. As shown in FIG. 6, the method may include the following steps.

In step 601, first indication information is transmitted to a network device, where the first indication information is used to indicate whether a terminal device has a model training capability.

In the embodiment of the present disclosure, step 601 may be implemented in any of manners in the embodiments of the present disclosure, which is not limited by the embodiment of the present disclosure and will not be repeated again.

It may be appreciated that in the embodiments of the present disclosure, the network device training the channel estimation model means that the terminal device does not have the model training capability; or the terminal device has the model training capability, but the network device may choose not to perform model training on the side of the terminal device based on a service condition, etc.

In the embodiment of the present disclosure, in a case where the first indication information is model training capability indication information of the terminal device, the terminal device may also need to transmit storage capability information, hardware processing capability information, computing capability information, power consumption capability information, or the like to the network device, used by the network device to determine a channel estimation model that matches the terminal device. Alternatively, the terminal device may also transmit model recommendation information to the network device based on its own hardware capability, used by the network device to determine a channel estimation model that matches the terminal device.

In step 602, a trained channel estimation model transmitted by the network device is received.

In the embodiment of the present disclosure, the terminal device may receive the trained channel estimation model transmitted by the network device.

In an implementation, the network device may transmit the trained channel estimation model to the terminal device in a form such as RRC signaling, a new signaling radio bearer (SRB), or a channel identified by a unique LCID.

In an embodiment of the present disclosure, the network device may obtain a simulation signal received by the terminal device in a simulation channel, and the simulation signal is a second DMRS transmitted by the network device based on a second DMRS pattern in the simulation channel. Training data for the channel estimation model may be determined based on the simulation signal, and the training data may be used to train the channel estimation model.

The second DMRS pattern may be a legacy DMRS pattern.

In an embodiment of the present disclosure, in a simulation channel model, the network device transmits DMRS to the terminal device based on the second DMRS pattern, the terminal device may obtain the simulation signal received in the simulation channel, and may determine the simulation data as training data to perform model training.

In an implementation, in an embodiment of the present disclosure, the terminal device may directly use the simulation signal of the received second DMRS as training data for the channel estimation model, or may obtain a channel estimated value estimated based on the simulation signal of the second DMRS and may use the channel estimated value as training data for the channel estimation model, or may also obtain other training data based on configuration of the channel estimation model, which is not limited in the present disclosure. The performing channel estimation based on the second DMRS to obtain the channel estimated value at the DMRS may include performing estimation by using the least square (LS) method, or the minimum mean square error (MMSE) method, or other estimation algorithms, etc., which is not limited in the present disclosure.

In some implementations, the network device trains the channel estimation model in a supervised machine learning manner, and the network device may also obtain the ideal channel label of the simulation channel to train the channel estimation model. It may be appreciated that in the simulation channel model, the ideal channel label of the simulation channel may be obtained via channel parameters for establishing the simulation channel model.

In the embodiment of the present disclosure, the network device may perform model training by itself, or the model training is performed by an OTT server, OAM, LMF, or the like.

In an embodiment of the present disclosure, the model trained by the network device may be determined based on model recommendation information reported by the terminal device. Alternatively, the model may be a model determined by the network device, which matches the capability of the terminal device (for example, the model is determined by the network device based on storage capacity, hardware processing capability information, computing capability information, power consumption capability information, or the like reported by the terminal device, and matches the terminal device). Alternatively, the model may be directly determined by the network device, and may be not based on the capability of the terminal device.

It should be noted that in the embodiment of the present disclosure, the training of the model may be performed online or offline, which is not limited in the present disclosure.

In step 603, a first DMRS transmitted by the network device based on a first DMRS pattern is received.

In step 604, channel estimation is performed based on the channel estimation model and the first DMRS.

In the embodiments of the present disclosure, steps 603 and 604 may be implemented in any of manners in the embodiments of the present disclosure, which is not limited by the embodiment of the present disclosure and will not be repeated again.

In summary, first indication information is transmitted to a network device, where the first indication information is used to indicate whether a terminal device has a model training capability; a trained channel estimation model transmitted by the network device is received; a first DMRS transmitted by the network device based on a first DMRS pattern is received; and channel estimation is performed based on the channel estimation model and the first DMRS. In this way, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

Reference is made to FIG. 7, which is a schematic flowchart of a channel estimation method according to an embodiment of the present disclosure. It should be noted that the channel estimation method in the embodiment of the present disclosure is performed by a network device. This method may be performed independently or in conjunction with any other embodiment of the present disclosure. As shown in FIG. 7, the method may include the following steps.

In step 701, a first DMRS is transmitted to a terminal device based on a first DMRS pattern, where the first DMRS is used for channel estimation based on a channel estimation model.

In the embodiment of the present disclosure, the network device may transmit the first DMRS to the terminal device based on the first DMRS pattern. After receiving the first DMRS, the terminal device may perform channel estimation based on the first DMRS and a trained channel estimation model.

In some implementations, the network device may receive first indication information transmitted by the terminal device, and the network device may determine whether the terminal device has a model training capability based on the first indication information.

In an implementation, the first indication information may include at least one of: model training capability indication information of the terminal device; hardware processing capability information of the terminal device; computing capability information of the terminal device; or power consumption capability information of the terminal device.

The model training capability indication information of the terminal device may indicate whether the terminal device has the model training capability. The model training capability indication information may be at least one bit.

In some implementations, the terminal device may also transmit model inference capability indication information of the terminal device to the network device. The model inference capability indication information of the terminal device may indicate whether the terminal device has a capability of using a channel estimation model for model inference. The model inference capability indication information may also be at least one bit.

It may be appreciated that in various embodiments of the present disclosure, the terminal device having the model inference capability is capable of performing channel estimation based on a trained channel estimation model.

In an implementation, the first indication information may be included in at least one of the following signaling: UE capability; UE assistance information (UAI); radio resource control (RRC) signaling; medium access control control element (MAC CE); or uplink control information (UCI). The first indication information may also be transmitted via a physical uplink shared channel (PUSCH).

In the embodiment of the present disclosure, the terminal device can perform channel estimation based on the received first DMRS and the trained channel estimation model.

It may be appreciated that in the embodiments of the present disclosure, the terminal device may directly use the received DMRS signal as an input of the channel estimation model, or may use a channel estimated value estimated based on the first DMRS as an input of the channel estimation model, which is not limited in the present disclosure. The performing channel estimation based on the DMRS to obtain the channel estimated value at DMRS may include performing estimation by using the least square (LS) method, or the minimum mean square error (MMSE) method, or other estimation algorithms, etc., which is not limited in the present disclosure.

In the embodiments of the present disclosure, the training the channel estimation model may be performed by the terminal device or the network device; the training may be performed by using actual data or simulation data; the training may be performed offline or online.

In some implementations, the network device may transmit a second DMRS to the terminal device based on a second DMRS pattern, where the second DMRS is used to determine training data for the channel estimation model.

In an implementation, the terminal device may use the determined training data to train the channel estimation model.

In an implementation, the terminal device may transmit the training data to the network device, and the network device uses the training data to train the channel estimation model.

In an implementation, before the terminal device determines the training data to be transmitted to the network device, the network device may also transmit fourth indication information to the terminal device, where the fourth indication information is used to indicate a type of the training data. For example, it may be indicated that the training data is a received signal corresponding to the second DMRS, or it may be indicated that the training data is a channel estimated value estimated based on the second DMRS. The terminal device may determine which type of training data is required by the network device for model training according to indication of the fourth indication information, may determine the training data according to the received second DMRS and may transmit the same to the network device.

In some implementations, the channel estimation model is trained by the terminal device using simulation training data. The terminal device may obtain a simulation signal received by the terminal device in a simulation channel, where the simulation signal is a second DMRS transmitted by the network device based on a second DMRS pattern in the simulation channel. The terminal device may determine the simulation training data for the channel estimation model according to the simulation signal, and may train the channel estimation model by using the simulation training data.

In some implementations, the channel estimation model is trained by the network device using simulation training data. The network device may also obtain the simulation signal received by the terminal device in a simulation channel, where the simulation signal is a second DMRS transmitted by the network device based on a second DMRS pattern in the simulation channel. The network device may also determine the simulation training data for the channel estimation model based on the simulation signal, and may train the channel estimation model by using the simulation training data.

In an embodiment of the present disclosure, in a case where the channel estimation model is trained by the network device, the network device may transmit the trained channel estimation model.

In some implementations of the embodiments of the present disclosure, in a case where the channel estimation model is trained by the terminal device, the network device may also receive second indication information transmitted by the terminal device, where the second indication information is used to indicate that training of the channel estimation model is completed.

In an implementation, in addition to the indication information for indicating completion of the model training, the second indication information may also include at least one of the following information: capability information of the channel estimation model, or processing delay information of the channel estimation model. Alternatively, the indication information for indicating completion of the model training is implicitly indicated by at least one of the above two types of information.

The capability information of the channel estimation model refers to a capability of the channel estimation model as compared with conventional channel estimation methods. For example, the model is capable of using a DMRS with a lower density for channel estimation as compared with conventional patterns, or the model is capable of obtaining a channel estimation result with a higher precision as compared with conventional channel estimation methods, etc. The processing delay information of the channel estimation model refers to a processing delay of the terminal device when using the model, which may include a loading time of the model, a time of using the model for inference, etc.

The network device may determine that the channel estimation model has been trained based on the second indication information. At the same time, the network device may also obtain the capability information of the model and/or information such as the processing delay of the model, the model complexity, the model inference power consumption, or etc., and may reasonably schedule the terminal device based on the capability information and the processing delay information; and may decide whether to enable an AI model based on the information such as the processing delay of the model, the model complexity, the model inference power consumption, or etc.

In an implementation, the second indication information may be included in at least one of the following signaling: UE capability; UE assistance information (UAI); radio resource control (RRC) signaling; medium access control control element (MAC CE); or uplink control information (UCI). The second indication information may also be transmitted via a PUSCH.

In some implementations, in a case where the channel estimation model is trained by the terminal device, the network device may also transmit third indication information to the terminal device, where the third indication information is used to instruct the terminal device to start to train the channel estimation model. The third indication information may be at least one bit.

In some implementations, in a case where the channel estimation model is trained by the terminal device, the terminal device may directly start to train the channel estimation model, or may start to train the model after more than a preset duration after transmitting the first indication information. The preset duration may be configured by the network device, or agreed or stipulated by a protocol.

In some implementations, the network device may transmit disable signaling to the terminal device according to service needs, conditions and the like, to instruct the terminal device not to start model training.

In some implementations, in a case where the channel estimation model is trained in a supervised machine learning manner, the network device may also transmit an impulse signal to the terminal device, and the terminal device may obtain an ideal channel estimation label of a channel based on the impulse signal. The ideal channel estimation label is used for the training the channel estimation model.

In some implementations, in a case where the channel estimation model is trained by the terminal device, if the channel estimation model is trained in a supervised machine learning manner, the network device may also receive auxiliary information from the terminal device to request the network device to transmit an impulse signal. The terminal device may obtain the ideal channel estimation label of the channel based on the impulse signal, and may train the channel estimation model by using the ideal channel estimation label.

In some implementations, the channel estimation model has a capability of using low-density DMRS for channel estimation, and a density of the first DMRS pattern is lower than a density of the second DMRS pattern. The second DMRS pattern may be a legacy DMRS pattern. The terminal device may obtain a channel estimation result based on the channel estimation model by using the DMRS with the lower density than the legacy DMRS pattern.

In some implementations, the channel estimation model has a capability of generating a high-precision channel estimation result, and a density of the first DMRS pattern is the same as a density of the second DMRS pattern. The second DMRS pattern may be a legacy DMRS pattern, and the terminal device may obtain a higher-precision channel estimation result based on the channel estimation model by using the DMRS with the same density as the legacy DMRS pattern, as compared with conventional channel estimation methods.

In some implementations, the network device may also transmit fifth indication information to the terminal device, where the fifth indication information is used to instruct the terminal device to perform channel estimation based on the channel estimation model. The trained channel estimation model will be enabled for channel estimation, only when the terminal device receives the fifth indication information.

In an implementation, the fifth indication information may be at least one bit, which directly instructs the terminal device to enable the trained channel estimation model to perform channel estimation. The fifth indication information may also be configuration of the first DMRS pattern transmitted by the network device to the terminal device, so as to reduce pilot overhead.

In summary, by transmitting a first DMRS to a terminal device based on a first DMRS pattern, where the first DMRS is used for channel estimation based on a channel estimation model, terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

In addition, In an implementation, in various embodiments of the present disclosure, model update may also be performed for online model training, and a model update cycle may be defined. Before the model update cycle ends, the terminal device needs to complete a new round of model training and/or model testing, and perform re-deployment on the retrained model. In some implementations, considering that model loading such as model re-deployment may take a certain duration, within this duration, the terminal device may use the original model for inference according to its own storage capacity (for example, the terminal device can store at least two models, and the new model will not overwrite the original model), or may use a conventional method for channel estimation (for example, the new model stored in the terminal device will overwrite the original model). This duration may be configured or indicated by the network device, or stipulated by a protocol.

The model update cycle may be configured by the network device. Alternatively, the terminal device reports the shortest model update cycle as supported, and the network device configures a reasonable model update cycle based on the report of the terminal device. Alternatively, the network device enables or disables an online model training function based on an update cycle reported by the terminal device (considering that if the model update (re-development) takes too long, a model trained based on channel data at the beginning of the update may no longer meet the current channel environment or the like, thus, the model training function may be disabled to avoid meaningless work). Alternatively, the shortest model training/update cycle is stipulated by a protocol, and the terminal device decides whether to perform online model training and update based on its actual situation.

Referring to FIG. 8, FIG. 8 is a schematic flowchart of a channel estimation method according to an embodiment of the present disclosure. It should be noted that the channel estimation method in the embodiment of the present disclosure is performed by a network device. This method may be performed independently or in conjunction with any other embodiment of the present disclosure. As shown in FIG. 8, the method may include the following steps.

In step 801, a first DMRS transmitted by a terminal device based on a first DMRS pattern is received.

In the embodiment of the present disclosure, the network device can receive the first DMRS transmitted by the terminal device, and the first DMRS is transmitted by the terminal device based on the first DMRS pattern. After receiving the first DMRS, the network device can perform uplink channel estimation based on the first DMRS and a trained channel estimation model.

In some implementations, the network device may receive a second DMRS transmitted by the terminal device based on a second DMRS pattern, may determine training data for a channel estimation model based on the second DMRS, and may use the training data to train the channel estimation model. The second DMRS pattern may be a legacy DMRS pattern.

In an implementation, in the embodiments of the present disclosure, the network device may directly use a signal of the received second DMRS as training data for the channel estimation model, or may use a channel estimated value estimated based on the second DMRS as training data for the channel estimation model, or may obtain other training data based on configuration of the channel estimation model, which is not limited in the present disclosure. The performing channel estimation based on the second DMRS to obtain the channel estimated value may include performing estimation by using the least square (LS) method, or the minimum mean square error (MMSE) method, or other estimation algorithms, etc., which is not limited in the present disclosure.

In some implementations, the network device trains the channel estimation model in a supervised machine learning manner. The network device may also transmit indication information to the terminal device. The indication information is used to instruct the terminal device to transmit an impulse signal. The network device receives the impulse signal transmitted by the terminal device, and can obtain an ideal channel label of a channel based on the impulse signal, for training the channel estimation model.

A transmission period of the impulse signal, a time-frequency resource occupied by the impulse signal and the like may be configured by the network device, or may be dynamically scheduled and indicated by the network device.

It should be noted that the impulse signal transmitted by the terminal device may be transmitted separately from the second DMRS, or may be transmitted together with the second DMRS, which is not limited in the present disclosure.

In some implementations, the network device may obtain a simulation signal received by the network device in a simulation channel, where the simulation signal is the second DMRS transmitted by the terminal device in the simulation channel based on the second DMRS pattern. The network device may determine simulation training data for the channel estimation model according to the simulation signal, and may train the channel estimation model by using the simulation training data.

In the embodiment of the present disclosure, the channel estimation model may be trained in a supervised machine learning manner or an unsupervised machine learning manner.

It should be noted that the channel estimation model in the embodiments of the present disclosure may be constructed and trained based on any one of machine learning methods, such as convolutional neural networks (CNN), etc., which is not limited in the present disclosure.

In the embodiment of the present disclosure, the channel estimation model may be trained using actual data or simulation data; it may be trained offline or online.

It may be appreciated that in the embodiment of the present disclosure, both the first DMRS pattern and the second DMRS pattern are determined by the terminal device based on configuration and/or indication of the network device.

In step 802, channel estimation is performed based on the channel estimation model and the first DMRS.

In the embodiment of the present disclosure, the network device can perform channel estimation based on the received first DMRS and the trained channel estimation model.

It may be appreciated that in the embodiments of the present disclosure, the network device may directly use the received DMRS signal as an input of the channel estimation model, or may obtain a channel estimated value estimated based on the DMRS and may use the channel estimated value as an input of the channel estimation model, which is not limited by the present disclosure. The performing channel estimation based on the DMRS to obtain the channel estimated value may include performing estimation by using the least square (LS) method, or the minimum mean square error (MMSE) method, or other estimation algorithms, etc., and the present disclosure is not limited thereto.

In some implementations, the channel estimation model has a capability of using low-density DMRS for channel estimation, and a density of the first DMRS pattern is lower than a density of the second DMRS pattern. The second DMRS pattern may be a legacy DMRS pattern. The network device can obtain an uplink channel estimation result based on the channel estimation model by using a DMRS with the lower density than the legacy DMRS pattern. The network device can configure or instruct the terminal device to reduce the density of DMRS pattern based on the capability of its own trained model.

In some implementations, the channel estimation model has a capability of generating a high-precision channel estimation result, and a density of the first DMRS pattern is the same as a density of the second DMRS pattern. The second DMRS pattern may be a legacy DMRS pattern. The network device may obtain a higher-precision channel estimation result based on the channel estimation model by using the DMRS with the same density as the legacy DMRS pattern, as compared with conventional channel estimation methods.

In some implementations, for online model training and model updating, in a case where the network device uses a conventional method for uplink channel estimation when performing model update, if the network device has configured or instructed the terminal device to reduce the density of the DMRS pattern, the network device may also need to configure or indicate the terminal device a high-density DMRS pattern (such as a legacy DMRS pattern).

It may be appreciated that after training of the channel estimation model has been completed, the network device may flexibly choose whether to use the channel estimation model for channel estimation based on actual conditions. If the network device uses the channel model for channel estimation, the network device may configure or indicate, based on the capability of the model, the terminal device a DMRS pattern with a reduced density as compared with the conventional pattern, or a legacy DMRS pattern. If the network device does not use the channel model for channel estimation, the network device may configure or indicate the terminal device a high-density DMRS pattern (such as a legacy DMRS pattern).

In summary, by receiving a first DMRS transmitted by a terminal device based on a first DMRS pattern, and performing channel estimation based on a channel estimation model and the first DMRS, the network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

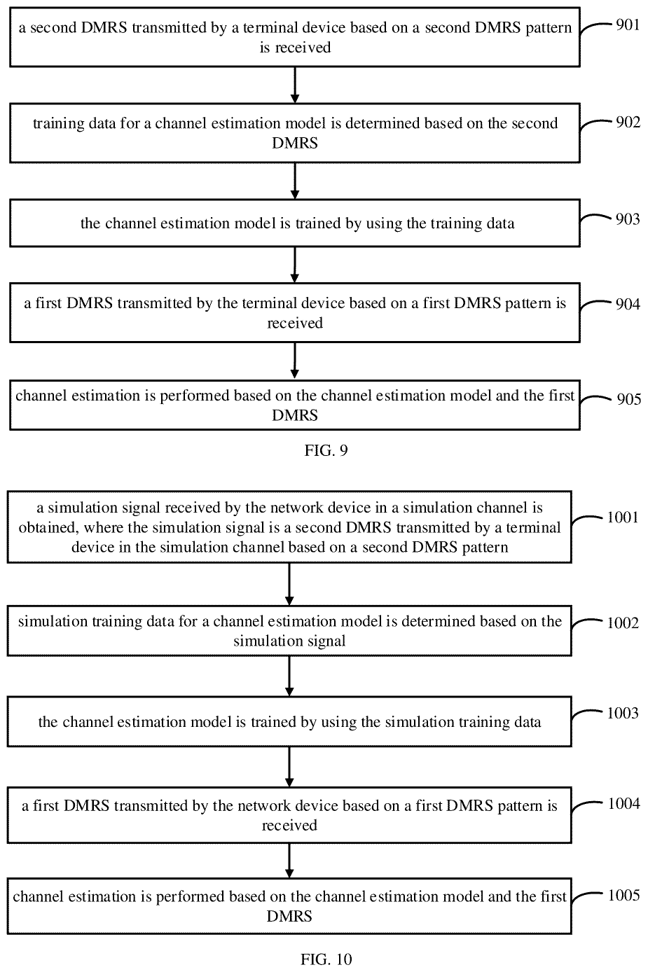

Referring to FIG. 9, FIG. 9 is a schematic flowchart of a channel estimation method according to an embodiment of the present disclosure. It should be noted that the channel estimation method in the embodiment of the present disclosure is performed by a network device. This method may be performed independently or in conjunction with any other embodiment of the present disclosure. As shown in FIG. 9, the method may include the following steps.

In step 901, a second DMRS transmitted by a terminal device based on a second DMRS pattern is received.

In the embodiment of the present disclosure, the network device may receive the second DMRS transmitted by the terminal device based on the second DMRS pattern, may determine training data for a channel estimation model based on the second DMRS, and may use the training data to train the channel estimation model. The second DMRS pattern may be a legacy DMRS pattern.

In some implementations, the network device trains the channel estimation model in a supervised machine learning manner. The network device may also transmit indication information to the terminal device. The indication information is used to instruct the terminal device to transmit an impulse signal. The network device receives the impulse signal transmitted by the terminal device, and can obtain an ideal channel label of a channel based on the impulse signal, for training the channel estimation model.

A transmission period of the impulse signal, a time-frequency resource occupied by the impulse signal, and the like may be configured by the network device, or may be dynamically scheduled and indicated by the network device.

It should be noted that the impulse signal transmitted by the terminal device may be transmitted separately from the second DMRS, or may be transmitted together with the second DMRS, which is not limited in the present disclosure.

In step 902, training data for a channel estimation model is determined based on the second DMRS.

In the embodiment of the present disclosure, the network device may determine the training data for the channel estimation model based on the received second DMRS. The training data is actual data obtained via actual channel transmission.

In an implementation, in the embodiments of the present disclosure, the network device may directly use a signal of the received second DMRS as training data for the channel estimation model, or may use a channel estimated value estimated based on the second DMRS as training data for the channel estimation model, or may obtain other training data based on configuration of the channel estimation model, which is not limited in the present disclosure. The performing channel estimation based on the second DMRS to obtain the channel estimated value may include performing estimation by using the least square (LS) method, or the minimum mean square error (MMSE) method, or other estimation algorithms, etc., which is not limited in the present disclosure.

In some implementations, the network device trains the channel estimation model in a supervised machine learning manner. The network device may also transmit indication information to the terminal device. The indication information is used to instruct the terminal device to transmit an impulse signal. The network device receives the impulse signal transmitted by the terminal device.

It should be noted that the impulse signal transmitted by the terminal device may be transmitted separately from the second DMRS, or may be transmitted together with the second DMRS, which is not limited in the present disclosure.

In step 903, the channel estimation model is trained by using the training data.

In the embodiment of the present disclosure, the network device may use the training data determined in the previous steps to train the channel estimation model.

In the embodiment of the present disclosure, the channel estimation model may be trained in a supervised machine learning manner or an unsupervised machine learning manner It should be noted that the channel estimation model in the embodiments of the present disclosure may be constructed and trained based on any one of machine learning methods, such as convolutional neural networks (CNN), etc., and the present disclosure is not limited thereto.

In some implementations, the network device trains the channel estimation model in a supervised machine learning manner, and the network device may also use an ideal channel label of a channel obtained based on the received impulse signal to train the channel estimation model.

In step 904, a first DMRS transmitted by the terminal device based on a first DMRS pattern is received.

In step 905, channel estimation is performed based on the channel estimation model and the first DMRS.

In the embodiments of the present disclosure, steps 904 and 905 may be implemented in any manner in the embodiments of the present disclosure, which is not limited by the embodiment of the present disclosure and will not be repeated again.

In summary, by receiving a second DMRS transmitted by a terminal device based on a second DMRS pattern; determining training data for a channel estimation model based on a second DMRS, training the channel estimation model by using the training data; receiving a first DMRS transmitted by the terminal device based on a first DMRS pattern; and performing channel estimation based on the channel estimation model and the first DMRS, the network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

Referring to FIG. 10, FIG. 10 is a schematic flowchart of a channel estimation method according to an embodiment of the present disclosure. It should be noted that the channel estimation method in the embodiment of the present disclosure is performed by a network device. This method may be performed independently or in conjunction with any other embodiment of the present disclosure. As shown in FIG. 10, the method may include the following steps.

In step 1001, a simulation signal received by the network device in a simulation channel is obtained, where the simulation signal is a second DMRS transmitted by a terminal device in the simulation channel based on a second DMRS pattern.

In the embodiment of the present disclosure, the network device may obtain the simulation signal received by the network device in the simulation channel, and the simulation signal is the second DMRS transmitted by the terminal device in the simulation channel based on the second DMRS pattern. Training data for the channel estimation model may be determined based on the simulation signal, and the training data may be used to train the channel estimation model.

The second DMRS pattern may be a legacy DMRS pattern.

In the embodiment of the present disclosure, in a simulation channel model, the terminal device transmits DMRS to the network device based on the second DMRS pattern, and the network device may obtain the simulation signal received in the simulation channel, and may determine the simulation data as training data for model training.

In step 1002, simulation training data for a channel estimation model is determined based on the simulation signal.

In the embodiment of the present disclosure, the network device may determine the training data for the channel estimation model based on the obtained simulation signal. The training data is simulation data transmitted in the simulation channel.

In an implementation, in an embodiment of the present disclosure, the network device may directly use the simulation signal of the received second DMRS as training data for the channel estimation model, or may use a channel estimated value estimated based on the simulation signal of the second DMRS as training data for the channel estimation model, or may also obtain other training data based on configuration of the channel estimation model, which is not limited in the present disclosure. The performing channel estimation based on the second DMRS to obtain the channel estimated value at the DMRS may include performing estimation by using the least square (LS) method, or the minimum mean square error (MMSE) method, or other estimation algorithms, etc., which is not limited in the present disclosure.

In some implementations, the network device trains the channel estimation model in a supervised machine learning manner, and the network device may also obtain an ideal channel label of the simulation channel to train the channel estimation model.

In step 1003, the channel estimation model is trained by using the simulation training data.

In the embodiment of the present disclosure, the network device may use the simulation training data determined in the previous steps to train the channel estimation model.

In the embodiment of the present disclosure, the channel estimation model may be trained in a supervised machine learning manner or an unsupervised machine learning manner.

It should be noted that the channel estimation model in the embodiments of the present disclosure may be constructed and trained based on any one of machine learning methods, such as convolutional neural networks (CNN), etc., and the present disclosure is not limited thereto.

In some implementations, the network device trains the channel estimation model in a supervised machine learning manner, and the network device may also obtain the ideal channel label of the simulation channel to train the channel estimation model. It may be appreciated that in the simulation channel model, the ideal channel label of the simulation channel may be obtained via channel parameters for establishing the simulation channel model.

In step 1004, a first DMRS transmitted by the network device based on a first DMRS pattern is received.

In step 1005, channel estimation is performed based on the channel estimation model and the first DMRS.

In the embodiment of the present disclosure, steps 1004 and 1005 may be implemented in any manner in the embodiments of the present disclosure, which is not limited by the embodiment of the present disclosure and will not be repeated again.

In summary, by obtaining a simulation signal received by a network device in a simulation channel, where the simulation signal is a second DMRS transmitted by a terminal device in the simulation channel based on the second DMRS pattern; determining simulation training data for a channel estimation model based on the simulation signal; training the channel estimation model by using the simulation training data; receiving a first DMRS transmitted by the network device based on a first DMRS pattern; and performing channel estimation based on the channel estimation model and the first DMRS, the network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

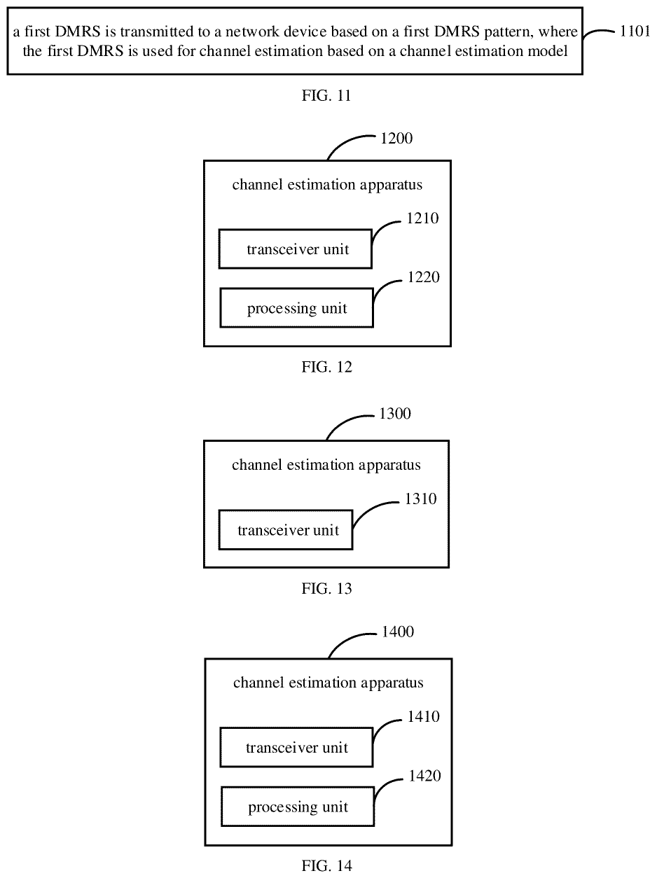

Reference to FIG. 11, which is a schematic flowchart of a channel estimation method according to an embodiment of the present disclosure. It should be noted that the channel estimation method in the embodiment of the present disclosure is performed by a terminal device. This method may be performed independently or in conjunction with any other embodiment of the present disclosure. As shown in FIG. 11, the method may include the following steps.

In step 1101, a first DMRS is transmitted to a network device based on a first DMRS pattern, where the first DMRS is used for channel estimation based on a channel estimation model.

In the embodiment of the present disclosure, the terminal device may transmit the first DMRS to the network device based on the first DMRS pattern. After receiving the first DMRS, the network device may perform uplink channel estimation based on the first DMRS and the trained channel estimation model. The first DMRS pattern is determined by the terminal device based on the configuration and/or indication of the network device.

In some implementations, the terminal device may transmit a second DMRS to the network device based on a second DMRS pattern, and the network device may determine training data for the channel estimation model based on the second DMRS, and may use the training data to train the channel estimation model. The second DMRS pattern may be a legacy DMRS pattern. The second DMRS pattern is also determined by the terminal device based on configuration and/or indication of the network device.

In an implementation, in the embodiments of the present disclosure, the network device may directly use a signal of the received second DMRS as training data for the channel estimation model, or may use a channel estimated value estimated based on the second DMRS as training data for the channel estimation model, or may obtain other training data based on configuration of the channel estimation model, which is not limited in the present disclosure. The performing channel estimation based on the second DMRS to obtain the channel estimated value may include performing estimation by using the least square (LS) method, or the minimum mean square error (MMSE) method, or other estimation algorithms, etc., which is not limited in the present disclosure.

In some implementations, the network device trains the channel estimation model in a supervised machine learning manner, and the terminal device may receive indication information transmitted by the network device. The indication information is used to instruct the terminal device to transmit an impulse signal. The network device receives the impulse signal transmitted by the terminal device, and can obtain an ideal channel label of a channel based on the impulse signal, for training the channel estimation model.

A transmission period of the impulse signal, a time-frequency resource occupied by the impulse signal and the like may be configured by the network device, or may be dynamically scheduled and indicated by the network device.

It should be noted that the impulse signal transmitted by the terminal device may be transmitted separately from the second DMRS, or may be transmitted together with the second DMRS, which is not limited in the present disclosure.

In some implementations, the network device may obtain a simulation signal received by the network device in a simulation channel, where the simulation signal is the second DMRS transmitted by the terminal device in the simulation channel based on the second DMRS pattern. The network device may determine simulation training data for the channel estimation model according to the simulation signal, and may train the channel estimation model by using the simulation training data.

In the embodiment of the present disclosure, the channel estimation model may be trained in a supervised machine learning manner or an unsupervised machine learning manner.

It should be noted that the channel estimation model in the embodiments of the present disclosure may be constructed and trained based on any one of machine learning methods, such as convolutional neural networks (CNN), etc., and the present disclosure is not limited thereto.

In the embodiment of the present disclosure, the channel estimation model may be trained using actual data or simulation data; it may be trained offline or online.

In the embodiment of the present disclosure, the network device may perform channel estimation based on the received first DMRS and the trained channel estimation model.

It may be appreciated that in the embodiment of the present disclosure, the terminal device may directly use a received DMRS signal as an input of the channel estimation model, or may use a channel estimated value estimated based on the DMRS as an input of the channel estimation model, which is not limited in the present disclosure. The performing channel estimation based on the DMRS to obtain the channel estimated value at the DMRS may include performing estimation by using the least square (LS) method, or the minimum mean square error (MMSE) method, or other estimation algorithms, etc., and the present disclosure is not limited thereto.

In some implementations, the channel estimation model has a capability of using low-density DMRS for channel estimation, and a density of the first DMRS pattern is lower than a density of the second DMRS pattern. The second DMRS pattern may be a legacy DMRS pattern. The network device can obtain an uplink channel estimation result based on the channel estimation model by using a DMRS with the lower density than the legacy DMRS pattern. The network device can configure or instruct the terminal device to reduce the density of DMRS pattern based on the capability of its own trained model.

In some implementations, the channel estimation model has a capability of generating a high-precision channel estimation result, and a density of the first DMRS pattern is the same as a density of the second DMRS pattern. The second DMRS pattern may be a legacy DMRS pattern. The network device may obtain a higher-precision channel estimation result based on the channel estimation model by using the DMRS with the same density as the legacy DMRS pattern, as compared with conventional channel estimation methods.

In some implementations, for online model training and model updating, in a case where the network device uses a conventional method for uplink channel estimation when performing model updates, if the network device has configured or instructed the terminal device to reduce the density of the DMRS pattern, the network device also needs to configure or indicate a high-density DMRS pattern (such as a legacy DMRS pattern) to the terminal device. The terminal device transmits the DMRS according to configuration or instruction of the network device.

In summary, by transmitting a first DMRS to a network device based on a first DMRS pattern, where the first DMRS is used for channel estimation based on a channel estimation model, the network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

Corresponding to the channel estimation method provided by the above embodiments, the present disclosure further provides a channel estimation apparatus. Since the channel estimation apparatus provided by embodiments of the present disclosure corresponds to the method provided by the above embodiments, implementations of the channel estimation method are also applicable to the channel estimation apparatus provided in the following embodiments, and will not be described in detail in the following embodiments.

Referring to FIG. 12, FIG. 12 is a schematic structural diagram of a channel estimation apparatus provided by an embodiment of the present disclosure.

As shown in FIG. 12, the channel estimation apparatus 1200 includes: a transceiver unit 1210 and a processing unit 1220.

The transceiver unit 1210 is configured to receive a first demodulation reference signal (DMRS) transmitted by a network device based on a first DMRS pattern.

The processing unit 1220 is configured to perform channel estimation based on a channel estimation model and the first DMRS.

In an implementation, the transceiver unit 1210 is further configured to: transmit first indication information to the network device, where the first indication information is used to indicate whether the terminal device has a model training capability.

In an implementation, the transceiver unit 1210 is further configured to: receive a second DMRS transmitted by the network device based on a second DMRS pattern; and determine training data for the channel estimation model based on the second DMRS.

In an implementation, the processing unit 1220 is further configured to: train the channel estimation model by using the training data.

In an implementation, the transceiver unit 1210 is further configured to: transmit the training data to the network device.

In an implementation, the processing unit 1220 is further configured to: obtain a simulation signal received by the terminal device in a simulation channel, where the simulation signal is a second DMRS transmitted by the network device based on a second DMRS pattern in the simulation channel; determine simulation training data for the channel estimation model according to the simulation signal; and train the channel estimation model by using the simulation training data.

In an implementation, the transceiver unit 1210 is further configured to: receive a trained channel estimation model transmitted by the network device.

In an implementation, the transceiver unit 1210 is further configured to: transmit second indication information to the network device, where the second indication information is used to indicate that training of the channel estimation model is completed.

In an implementation, the second indication information includes at least one of: capability information of the channel estimation model, or processing delay information of the channel estimation model.

In an implementation, the transceiver unit 1210 is further configured to: receive third indication information transmitted by the network device, where the third indication information is used to instruct the terminal device to start to train the channel estimation model.

In an implementation, the transceiver unit 1210 is further configured to: receive fourth indication information transmitted by the network device, where the fourth indication information is used to indicate a type of the training data.

In an implementation, a density of the first DMRS pattern is lower than a density of the second DMRS pattern; capability information of the channel estimation model is a capability of using low-density DMRS for channel estimation.

In an implementation, a density of the first DMRS pattern is the same as a density of the second DMRS pattern; capability information of the channel estimation model is a capability of generating a high-precision channel estimation result.

In an implementation, the transceiver unit 1210 is further configured to: receive an impulse signal transmitted by the network device; and determine an ideal channel estimation label of a channel based on the impulse signal, where the ideal channel estimation label is used for training the channel estimation model, and the channel estimation model is trained in a supervised machine learning manner.

In an implementation, the transceiver unit 1210 is further configured to: transmit auxiliary information to the network device, where the auxiliary information is used to request the impulse signal, where the ideal channel estimation label is used by the terminal device to train the channel estimation model.

In an implementation, the first indication information includes at least one of: model training capability indication information of the terminal device; hardware processing capability information of the terminal device; computing capability information of the terminal device; or power consumption capability information of the terminal device.

In an implementation, the transceiver unit 1210 is further configured to: receive fifth indication information transmitted by the network device, where the fifth indication information is used to instruct the terminal device to perform channel estimation based on the channel estimation model.

The channel estimation apparatus according to the embodiment can receive a first demodulation reference signal (DMRS) transmitted by a network device based on a first DMRS pattern, and perform channel estimation based on a channel estimation model according to the first DMRS, so that terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

Reference is made to FIG. 13, which is a schematic structural diagram of a channel estimation apparatus provided by an embodiment of the present disclosure.

As shown in FIG. 13, the channel estimation apparatus 1300 includes a transceiver unit 1310. The transceiver unit 1310 is configured to transmit a first demodulation reference signal (DMRS) to a terminal device based on a first DMRS pattern, where the first DMRS is used for channel estimation based on a channel estimation model.

In an implementation, the transceiver unit 1310 is further configured to: receive first indication information transmitted by the terminal device, where the first indication information is used to indicate whether the terminal device has a model training capability.

In an implementation, the transceiver unit 1310 is further configured to: transmit a second DMRS to the terminal device based on a second DMRS pattern, where the second DMRS is used to determine training data for the channel estimation model.

In an implementation, the transceiver unit 1310 is further configured to: receive the training data transmitted by the terminal device; and train the channel estimation model by using the training data.

In an implementation, the transceiver unit 1310 is further configured to: obtain a simulation signal received by the terminal device in a simulation channel, where the simulation signal is a second DMRS transmitted by the network device based on a second DMRS pattern in the simulation channel; determine simulation training data for the channel estimation model according to the simulation signal; and train the channel estimation model by using the simulation training data.

In an implementation, the transceiver unit 1310 is further configured to: receive a trained channel estimation model transmitted by the network device.

In an implementation, the transceiver unit 1310 is further configured to: receive second indication information transmitted by the terminal device, where the second indication information is used to indicate that training of the channel estimation model is completed.

In an implementation, the second indication information includes at least one of: capability information of the channel estimation model, or processing delay information of the channel estimation model.

In an implementation, the transceiver unit 1310 is further configured to: transmit third indication information to the terminal device, where the third indication information is used to instruct the terminal device to start to train the channel estimation model.

In an implementation, the transceiver unit 1310 is further configured to: transmit fourth indication information to the terminal device, where the fourth indication information is used to indicate a type of the training data.

In an implementation, a density of the first DMRS pattern is lower than a density of the second DMRS pattern; capability information of the channel estimation model is a capability of using low-density DMRS for channel estimation.

In an implementation, a density of the first DMRS pattern is the same as a density of the second DMRS pattern; capability information of the channel estimation model is a capability of generating a high-precision channel estimation result.

In an implementation, the transceiver unit 1310 is further configured to: transmit an impulse signal to the terminal device, where the impulse signal is used to determine an ideal channel estimation label of a channel, the ideal channel estimation label is used for training the channel estimation model, and the channel estimation model is trained in a supervised machine learning manner.

In an implementation, the transceiver unit 1310 is further configured to: receive auxiliary information transmitted by the terminal device, where the auxiliary information is used to request the impulse signal, where the ideal channel estimation label is used by the terminal device to train the channel estimation model.

In an implementation, the first indication information includes at least one of: model training capability indication information of the terminal device; hardware processing capability information of the terminal device; computing capability information of the terminal device; or power consumption capability information of the terminal device.

In an implementation, the transceiver unit 1310 is further configured to: transmit fifth indication information to the terminal device, where the fifth indication information is used to instruct the terminal device to perform channel estimation based on the channel estimation model.

The channel estimation apparatus according to the embodiment may transmit a first DMRS to a terminal device based on a first DMRS pattern, and the first DMRS is used for channel estimation based on a channel estimation model, so that terminal devices having different capabilities can support channel estimation based on the artificial intelligence technology, which effectively improves the accuracy of channel estimation and greatly increases the success rate of decoding, thereby effectively improving the spectrum efficiency of a communication system, and saving the pilot overhead of the system.

Reference is made to FIG. 14, which is a schematic structural diagram of a channel estimation apparatus provided by an embodiment of the present disclosure.

As shown in FIG. 14, the channel estimation apparatus 1400 includes: a transceiver unit 1410 and a processing unit 1420.

The transceiver unit 1410 is configured to receive a first demodulation reference signal (DMRS) transmitted by a network device based on a first DMRS pattern.

The processing unit 1420 is configured to perform channel estimation based on a channel estimation model and the first DMRS.

In an implementation, the transceiver unit 1410 is further configured to: receive a second DMRS transmitted by the terminal device based on a second DMRS pattern; determine training data for the channel estimation model based on the second DMRS; and train the channel estimation model by using the training data.

In an implementation, the transceiver unit 1410 is further configured to: transmit indication information to the terminal device, where the indication information is used to instruct the terminal device to transmit an impulse signal; receive the impulse signal transmitted by the terminal device; and determine an ideal channel estimation label of a channel based on the impulse signal, where the ideal channel estimation label is used for training the channel estimation model, and the channel estimation model is trained in a supervised machine learning manner.

In an implementation, the processing unit 1420 is further configured to: obtain a simulation signal received by the network device in a simulation channel, where the simulation signal is a second DMRS transmitted by the terminal device based on a second DMRS pattern in the simulation channel; determine simulation training data for the channel estimation model according to the simulation signal; and train the channel estimation model by using the simulation training data.

In an implementation, a density of the first DMRS pattern is lower than a density of the second DMRS pattern; capability information of the channel estimation model is a capability of using low-density DMRS for channel estimation.

In an implementation, a density of the first DMRS pattern is the same as a density of the second DMRS pattern; where capability information of the channel estimation model is a capability of generating a high-precision channel estimation result.

The channel estimation apparatus of the embodiment can receive a first DMRS transmitted by a terminal device based on a first DMRS pattern, and perform channel estimation based on a channel estimation model and the first DMRS, so that a network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

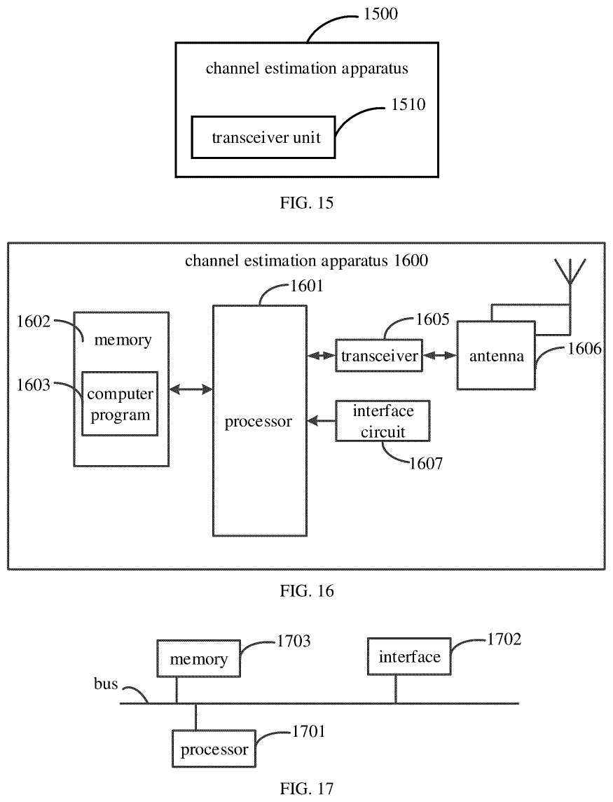

Reference is made to FIG. 15, which is a schematic structural diagram of a channel estimation apparatus provided by an embodiment of the present disclosure.

As shown in FIG. 15, the channel estimation apparatus 1500 includes a transceiver unit 1510. The transceiver unit 1510 is configured to transmit a first demodulation reference signal (DMRS) to a network device based on a first DMRS pattern, where the first DMRS is used for channel estimation based on a channel estimation model.

In an implementation, the transceiver unit 1510 is further configured to: transmit a second DMRS to the network device based on a second DMRS pattern, where the second DMRS is used to determine training data for the channel estimation model.

In an implementation, the transceiver unit 1510 is further configured to: receive indication information transmitted by the network device, where the indication information is used to instruct the terminal device to transmit an impulse signal; transmit the impulse signal to the network device; and determine an ideal channel estimation label of a channel based on the impulse signal, where the ideal channel estimation label is used for training the channel estimation model, and the channel estimation model is trained in a supervised machine learning manner.

In an implementation, a density of the first DMRS pattern is lower than a density of the second DMRS pattern; capability information of the channel estimation model is a capability of using low-density DMRS for channel estimation.

In an implementation, a density of the first DMRS pattern is the same as a density of the second DMRS pattern; capability information of the channel estimation model is a capability of generating a high-precision channel estimation result.

The channel estimation apparatus according to the embodiment may transmit a first DMRS to a network device based on a first DMRS pattern, where the first DMRS is used for channel estimation based on a channel estimation model, so that a network device can perform uplink channel estimation based on the artificial intelligence technology, which effectively improves the accuracy of channel estimation and greatly increases the success rate of decoding, thereby effectively improving the spectrum efficiency of a communication system, and saving the pilot overhead of the system.

In order to implement the above embodiments, an embodiment of the present disclosure further provides a communication device, including: a processor and a memory. A computer program is stored in the memory, and the processor is configured to execute the computer program stored in the memory to cause the device to perform the method in the embodiments as shown in FIG. 2 to FIG. 6.

In order to implement the above embodiments, an embodiment of the present disclosure further provides a communication device, including: a processor and a memory. A computer program is stored in the memory, and the processor is configured to execute the computer program stored in the memory to cause the device to perform the method in the embodiments as shown in FIG. 7.

In order to implement the above embodiments, an embodiment of the present disclosure further provides a communication device, including: a processor and a memory. A computer program is stored in the memory, and the processor is configured to execute the computer program stored in the memory to cause the device to perform the method in the embodiments as shown in FIG. 8 to FIG. 10.

In order to implement the above embodiments, an embodiment of the present disclosure further provides a communication device, including: a processor and a memory. A computer program is stored in the memory, and the processor is configured to execute the computer program stored in the memory to cause the device to perform the method in the embodiments as shown in FIG. 11.

In order to implement the above embodiments, an embodiment of the present disclosure further provides a communication device, including: a processor and an interface circuit. The interface circuit is configured to receive code instructions and transmit the same to the processor. The processor is configured to run the code instructions to perform the method in the embodiments as shown in FIG. 2 to FIG. 6.

In order to implement the above embodiments, an embodiment of the present disclosure further provides a communication device, including: a processor and an interface circuit. The interface circuit is configured to receive code instructions and transmit the same to the processor. The processor is configured to run the code instructions to perform the method in the embodiments as shown in FIG. 7.

In order to implement the above embodiments, an embodiment of the present disclosure further provides a communication device, including: a processor and an interface circuit. The interface circuit is configured to receive code instructions and transmit the same to the processor. The processor is configured to run the code instructions to perform the method in the embodiments as shown in FIG. 8 to FIG. 10.

In order to implement the above embodiments, an embodiment of the present disclosure further provides a communication device, including: a processor and an interface circuit. The interface circuit is configured to receive code instructions and transmit the same to the processor. The processor is configured to run the code instructions to perform the method in the embodiments as shown in FIG. 11.

Referring to FIG. 16, FIG. 16 is a schematic structural diagram of another channel estimation apparatus provided by an embodiment of the present disclosure. The channel estimation apparatus 1600 may be a network device or a terminal device, or may be a chip, a chip system, or a processor that supports the network device to implement the above method, or may be a chip, a chip system, or a processor that supports the terminal device to implement the above method. The apparatus can be used to implement the methods described in the above method embodiments. For details, reference can be made to the description in the above method embodiments.

The channel estimation apparatus 1600 may include one or more processors 1601. The processor 1601 may be a general-purpose processor or a special-purpose processor, or the like. For example, the processor may be a baseband processor or a central processing unit. The baseband processor may be used to process communication protocols and communication data. The central processor may be used to control the channel estimation apparatus (such as a base station, a baseband chip, a terminal device, a chip of the terminal device, a DU or a CU, etc.), to execute the computer program, and to process data in the computer program.

In an implementation, the channel estimation apparatus 1600 may also include one or more memories 1602, on which a computer program 1603 may be stored. The processor 1601 is configured to execute the computer program 1603 to cause the channel estimation apparatus 1600 to perform steps described in the above method embodiments. The computer program 1603 may be solidified in the processor 1601, in which case the processor 1601 may be implemented by hardware.

In an implementation, the memory 1602 may also store data. The channel estimation apparatus 1600 and the memory 1602 may be arranged separately or integrated together.

In an implementation, the channel estimation apparatus 1600 may also include a transceiver 1605 and an antenna 1606. The transceiver 1605 may be referred to as a transceiver unit, a transceiver module, a transceiver circuit, etc., and is configured to implement receiving and transmitting functions. The transceiver 1605 may include a receiver and a transmitter. The receiver may be referred to as a receiver unit or a receiver circuit, etc., and configured to implement receiving function; the transmitter may be referred to as a transmitter unit, a transmitter circuit, etc., and configured to implement the transmitting function.

In an implementation, the channel estimation apparatus 1600 may also include one or more interface circuits 1607. The interface circuit 1607 is configured to receive code instructions and transmit them to the processor 1601. The processor 1601 is configured to execute the code instructions to cause the channel estimation apparatus 1600 to perform the method described in the above method embodiments.

In an implementation, the processor 1601 may include a transceiver for implementing receiving and transmitting functions. For example, the transceiver may be a transceiver circuit, an interface, or an interface circuit. The transceiver circuits, interfaces or interface circuits for implementing receiving and transmitting functions may be separated from each other or integrated together. The above-mentioned transceiver circuit, interface or interface circuit may be configured to read and write codes/data, or transmit or transfer signals.

In an implementation, the channel estimation apparatus 1600 may include a circuit, and the circuit may implement the functions of transmitting, receiving, or communicating in the foregoing method embodiments. The processor and the transceiver described in this disclosure may be implemented on an integrated circuit (IC), an analog IC, a radio frequency integrated circuit (RFIC), a mixed signal IC, a disclosure specific integrated circuits (ASIC), a printed circuit board (printed circuit board (PCB), electronic equipment, etc. The processor and the transceiver may be manufactured using various IC process technologies, such as complementary metal oxide semiconductor (CMOS), N-channel Metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The channel estimation apparatus described in the above embodiments may be a network device or a terminal device, the scope of the channel estimation apparatus described in this disclosure is not limited thereto, and the structure of the channel estimation apparatus may not be limited by FIG. 12 to FIG. 15. The channel estimation apparatus may be a stand-alone device or may be a part of a larger device. For example, the channel estimation apparatus may be:
(1) an independent integrated circuit (IC), or chip, or chip system or subsystem;
(2) a collection of one or more ICs, where, In an implementation, the IC collection may also include a storage component for storing data and a computer program;
(3)ASIC, such as modem;
(4) a module that can be embedded into other devices;
(5) a receiver, a terminal, an intelligent terminal, a cellular phone, a wireless equipment, a handheld device, a mobile unit, a vehicle-mounted equipment, a network device, a cloud equipment, an artificial intelligence equipment, etc.;
(6) other component(s), etc.

For the case where the channel estimation apparatus may be a chip or a chip system, reference may be made to the schematic structural diagram of the chip shown in FIG. 17. The chip shown in FIG. 17 includes a processor 1701 and an interface 1702. The number of processors 1701 may be one or multiple, and the number of interfaces 1702 may be multiple.

The case where the chip is configured to implement the functions of the network device in the embodiment of the present disclosure is as follows.

The interface 1702 is configured to read code instructions and transmit the same to the processor.

The processor 1701 is configured to run the code instructions to perform the methods shown in FIG. 2 to FIG. 6, or to perform the method shown in FIG. 11.

The case where the chip is configured to implement the functions of the terminal device in the embodiment of the present disclosure is as follows.

The interface 1702 is configured to read code instructions and transmit the same to the processor.

The processor 1701 is configured to run the code instructions to perform the method as shown in FIG. 7, or to perform the methods as shown in FIG. 8 to FIG. 10.

In an implementation, the chip further includes a memory 1703, which is used to store necessary computer programs and data.

Those skilled in the art can also understand that various illustrative logical blocks and steps listed in the embodiments of the present disclosure can be implemented by electronic hardware, computer software, or a combination of both. Whether such functions are implemented in hardware or software depends on the specific disclosure and the overall system design requirement. Those skilled in the art can use various methods to implement the described functions for each specific disclosure, but such implementation should not be understood as exceeding the protection scope of the embodiments of the present disclosure.

An embodiment of the present disclosure further provides a communication system, including a channel estimation apparatus as the terminal device and a channel estimation apparatus as the network device in the above embodiments in FIG. 8 and FIG. 9, or the system includes a channel estimation apparatus as the terminal device in the above embodiments in FIG. 10 and a channel estimation apparatus as a network device.

The present disclosure further provides a readable storage medium, on which instructions are stored. When the instructions are executed by a computer, functions of any of the above method embodiments are implemented.

The present disclosure further provides a computer program product. The computer program product is executed by a computer to implement functions of any of the above method embodiments.

The above embodiments may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in the embodiments of the present disclosure are generated in whole or in part. The computer may be a general-purpose computer, a special-purpose computer, a computer network, or other programmable device. The computer program may be stored in or transferred from one computer-readable storage medium to another computer-readable storage medium. For example, the computer program may be transferred from a website, a computer, a server, or a data center to another website, computer, server or data center to another website, a computer, a server, or a data center to another website, computer, server or data center through wired means (such as coaxial cable, optical fiber, digital subscriber line (DSL)) or wireless means (such as infrared, wireless, microwave, etc.). The computer-readable storage medium may be any available medium that can be accessed by a computer or a data storage device integrated by one or more available media, which includes a server, a data center, and so on. The available media may be magnetic media (e.g., floppy disk, hard disk, magnetic tape), optical media (e.g., high-density digital video discs (DVD)), or semiconductor media (e.g., solid state disk (SSD)) etc.

Those of ordinary skill in the art may appreciate that numerical numbers such as first and second involved in the present disclosure are only for convenience of description, and are not used to limit the scope of the embodiments of the present disclosure, or to indicate the order.

At least one in the present disclosure may also be described as one or more, and the plurality may be two, three, four or more, which are not limited by the present disclosure. In the embodiments of the present disclosure, technical features are distinguished by terms “first”, “second”, “third”, “A”, “B”, “C”, and “D”, etc. The technical features described by the terms “first”, “second”, “third”, “A”, “B”, “C” and “D” are not in an order of precedence or in an order of size.

The corresponding relationships shown in each table in the present disclosure can be configured or predefined. The values of the information in each table are only examples and can be configured as other values, which is not limited by the present disclosure. When the correspondence between information and each parameter is configured, it is not necessarily required to configure all the correspondences shown in each table. For example, in the table in the present disclosure, the correspondences shown in some rows may not be configured. For another example, appropriate form adjustments can be made based on the above table, such as splitting, merging, etc. The names of the parameters shown in the titles of the above tables may also be other names understandable by the communication apparatus, and the values or expressions of the parameters may also be other values or expressions understandable by the communication apparatus. When implementing the above tables, other data structures can also be used, such as array, queue, container, stack, linear list, pointer, linked list, tree, graph, structure, class, heap, distributed table or hash table.

The term “predefined” in the present disclosure may be understood as defined, pre-defined, storage, pre-storage, pre-negotiation, pre-configuration, solidification, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific disclosure and design constraints of the technical solution. Those of ordinary skill in the art may implement the described functionality using different methods for each specific disclosure, but such implementations should not be considered as exceeding the scope of the present disclosure.

Those of ordinary skill in the art can clearly understand that for the convenience and simplicity of description, reference may be made to the corresponding processes in the foregoing method embodiments for the specific working processes of the systems, devices and units described above, which will not be described again here.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The specific implementations do not construct as limitation onto the protection scope of the present disclosure. It should be understood by those skilled in the art that various modifications, combinations, subcombinations and substitutions can be made according to design requirements and other factors. Any modification, equivalent substitution and improvement made within the spirit and principle of the invention shall fall within the protection scope of the invention.

1. A channel estimation method, performed by a terminal device, comprising:
receiving a first demodulation reference signal (DMRS) transmitted by a network device based on a first DMRS pattern; and
performing channel estimation based on a channel estimation model and the first DMRS.

2. The method according to claim 1, further comprising:
transmitting first indication information to the network device, wherein the first indication information is used to indicate whether the terminal device has a model training capability.

3. (canceled)

4. The method according to claim 2, further comprising:
receiving a second DMRS transmitted by the network device based on a second DMRS pattern;
determining training data for the channel estimation model based on the second DMRS; and
training the channel estimation model by using the training data.

5. The method according to claim 2, further comprising:
receiving a second DMRS transmitted by the network device based on a second DMRS pattern;
determining training data for the channel estimation model based on the second DMRS; and
transmitting the training data to the network device;
wherein the method further comprises:
receiving a trained channel estimation model transmitted by the network device,
receiving fourth indication information transmitted by the network device, wherein the fourth indication information is used to indicate a type of the training data, or
both of (1) transmitting auxiliary information to the network device, wherein the auxiliary information is used to request an impulse signal, and (2) receiving the impulse signal transmitted by the network device, and determining an ideal channel estimation label of a channel based on the impulse signal, wherein the ideal channel estimation label is used by the terminal device to train the channel estimation model, and the channel estimation model is trained in a supervised machine learning manner.

6. The method according to claim 2, further comprising:
obtaining a simulation signal received by the terminal device in a simulation channel, wherein the simulation signal is a second DMRS transmitted by the network device based on a second DMRS pattern in the simulation channel;
determining simulation training data for the channel estimation model according to the simulation signal; and
training the channel estimation model by using the simulation training data;
wherein the method further comprises:
transmitting second indication information to the network device, wherein the second indication information is used to indicate that training of the channel estimation model is completed, or
receiving third indication information transmitted by the network device, wherein the third indication information is used to instruct the terminal device to start to train the channel estimation model;
wherein the second indication information comprises at least one of: capability information of the channel estimation model, or processing delay information of the channel estimation model.

7. The method according to claim 2, further comprising:
receiving a trained channel estimation model transmitted by the network device.

8. The method according to claim 4, further comprising:
transmitting second indication information to the network device, wherein the second indication information is used to indicate that training of the channel estimation model is completed; or
receiving third indication information transmitted by the network device, wherein the third indication information is used to instruct the terminal device to start to train the channel estimation model;
wherein the second indication information comprises at least one of: capability information of the channel estimation model, or processing delay information of the channel estimation model.

9.-13. (canceled)

14. The method according to claim 4, further comprising:
transmitting auxiliary information to the network device, wherein the auxiliary information is used to request an impulse signal;
receiving the impulse signal transmitted by the network device; and
determining an ideal channel estimation label of a channel based on the impulse signal, wherein the ideal channel estimation label is used by the terminal device to train the channel estimation model, and the channel estimation model is trained in a supervised machine learning manner.

15. (canceled)

16. (canceled)

17. The method according to claim 1, further comprising:
receiving fifth indication information transmitted by the network device, wherein the fifth indication information is used to instruct the terminal device to perform channel estimation based on the channel estimation model.

18. A channel estimation method, performed by a network device, comprising:
transmitting a first demodulation reference signal (DMRS) to a terminal device based on a first DMRS pattern,
wherein the first DMRS is used for channel estimation based on a channel estimation model.

19. The method according to claim 18, further comprising:
receiving first indication information transmitted by the terminal device, wherein the first indication information is used to indicate whether the terminal device has a model training capability.

20. The method according to claim 19, further comprising:
transmitting a second DMRS to the terminal device based on a second DMRS pattern,
wherein the second DMRS is used to determine training data for the channel estimation model;
wherein the method further comprises:
receiving second indication information transmitted by the terminal device, wherein the second indication information is used to indicate that training of the channel estimation model is completed, wherein the second indication information comprises at least one of capability information of the channel estimation model or processing delay information of the channel estimation model,
transmitting third indication information to the terminal device, wherein the third indication information is used to instruct the terminal device to start to train the channel estimation model, or
both of (1) receiving auxiliary information transmitted by the terminal device, wherein the auxiliary information is used to request an impulse signal, and (2) transmitting the impulse signal to the terminal device, wherein the impulse signal is used to determine an ideal channel estimation label of a channel, the ideal channel estimation label is used by the terminal device to train the channel estimation model, and the channel estimation model is trained in a supervised machine learning manner.

21. The method according to claim 19, further comprising:
transmitting a second DMRS to the terminal device based on a second DMRS pattern, wherein the second DMRS is used to determine training data for the channel estimation model;
receiving the training data transmitted by the terminal device; and
training the channel estimation model by using the training data,
wherein the method further comprises:
transmitting a trained channel estimation model to the terminal device,
transmitting fourth indication information to the terminal device, wherein the fourth indication information is used to indicate a type of the training data, or
both of (1) receiving auxiliary information transmitted by the terminal device, wherein the auxiliary information is used to request an impulse signal, and (2) transmitting the impulse signal to the terminal device, wherein the impulse signal is used to determine an ideal channel estimation label of a channel, the ideal channel estimation label is used by the terminal device to train the channel estimation model, and the channel estimation model is trained in a supervised machine learning manner.

22. The method according to claim 19, further comprising:
obtaining a simulation signal received by the terminal device in a simulation channel, wherein the simulation signal is a second DMRS transmitted by the network device based on a second DMRS pattern in the simulation channel;
determining simulation training data for the channel estimation model according to the simulation signal; and
training the channel estimation model by using the simulation training data,
wherein the method further comprises transmitting a trained channel estimation model to the terminal device.

23. (canceled)

24. The method according to claim 19, further comprising:
receiving second indication information transmitted by the terminal device, wherein the second indication information is used to indicate that training of the channel estimation model is completed; or
transmitting third indication information to the terminal device, wherein the third indication information is used to instruct the terminal device to start to train the channel estimation model,
wherein the second indication information comprises at least one of: capability information of the channel estimation model, or processing delay information of the channel estimation model.

25-33. (canceled)

34. A channel estimation method, performed by a network device, comprising:
receiving a first demodulation reference signal (DMRS) transmitted by a terminal device based on a first DMRS pattern; and
performing channel estimation based on a channel estimation model and the first DMRS.

35. The method according to claim 34, further comprising:
receiving a second DMRS transmitted by the terminal device based on a second DMRS pattern;
determining training data for the channel estimation model based on the second DMRS; and
training the channel estimation model by using the training data,
wherein the method further comprises:
transmitting indication information to the terminal device, wherein the indication information is used to instruct the terminal device to transmit an impulse signal;
receiving the impulse signal transmitted by the terminal device; and
determining an ideal channel estimation label of a channel based on the impulse signal, wherein the ideal channel estimation label is used for training the channel estimation model, and the channel estimation model is trained in a supervised machine learning manner.

36. (canceled)

37. The method according to claim 34, further comprising:
obtaining a simulation signal received by the network device in a simulation channel, wherein the simulation signal is a second DMRS transmitted by the terminal device based on a second DMRS pattern in the simulation channel;
determining simulation training data for the channel estimation model according to the simulation signal; and
training the channel estimation model by using the simulation training data.

38.-48. (canceled)

49. A terminal device, comprising:
a processor; and
a memory having stored therein a computer program executable by the processor,
wherein the processor is configured to perform the method according to claim 1.

50. A non-transitory computer-readable storage medium storing instructions that, when executed by a processor of a terminal device, cause the terminal device to implement the method according to claim 1.
